(19) United States
(12) Patent Application Publication
(10) Pub. No.: US 2023/0408937 A1
(43) Pub. Date: Dec. 21, 2023

(54) ELECTROPHOTOGRAPHIC PHOTOSENSITIVE MEMBER, PROCESS CARTRIDGE, AND ELECTROPHOTOGRAPHIC APPARATUS

(71) Applicant: CANON KABUSHIKI KAISHA, Tokyo (JP)

(72) Inventors: TAICHI SATO, Shizuoka (JP); SHUNTARO WATANABE, Kanagawa (JP); MASATADA HIROTA, Shizuoka (JP); KOHEI MAKISUMI, Shizuoka (JP); TOMOHITO ISHIDA, Shizuoka (JP); TSUTOMU NISHIDA, Shizuoka (JP)

(21) Appl. No.: 18/336,773

(22) Filed: Jun. 16, 2023

(30) Foreign Application Priority Data
Jun. 20, 2022 (JP) 2022-098930
Mar. 1, 2023 (JP) 2023-031096

(51) Int. Cl. G03G 5/05; G03G 15/01; G03G 15/08; G03G 5/06

(52) U.S. Cl. CPC G03G 5/0567; G03G 15/0105; G03G 15/0868; G03G 5/0662; G03G 2215/066

(57) ABSTRACT

An electrophotographic photosensitive member including a surface layer containing a binder resin and metal oxide particles. An average primary particle diameter of the metal oxide particles measured from a cross-section of the surface layer is 20 to 70 nm. A content ratio of the metal oxide particles in the surface layer measured from the cross-section of the surface layer is 30 to 75 vol % with respect to a total volume of the surface layer.

### BACKGROUND

### Technical Field

The present disclosure relates to an electrophotographic photosensitive member, and a process cartridge and an electrophotographic apparatus each including the electrophotographic photosensitive member.

### Description of the Related Art

As an electrophotographic photosensitive member to be mounted onto an electrophotographic apparatus, there is widely used an electrophotographic photosensitive member containing an organic photoconductive substance serving as a charge-generating substance. In recent years, an improvement in mechanical durability, that is, abrasion resistance, of the electrophotographic photosensitive member has been required for the purposes of lengthening a lifetime of the electrophotographic photosensitive member and improving image quality at the time of its repeated use.

Meanwhile, discharge that occurs between the electrophotographic photosensitive member and a charging member in a charging step produces oxidizing gases, such as ozone and a nitrogen oxide, and the oxidizing gases deteriorate a material used in a surface layer of the electrophotographic photosensitive member, to thereby produce a discharge product. Absorption of moisture in air by the discharge product may cause a phenomenon called “image smearing” in which an electrostatic latent image formed on the electrophotographic photosensitive member collapses.

Besides, as the abrasion resistance of the surface of the electrophotographic photosensitive member becomes higher, the above-mentioned substances causing the image smearing, such as the discharge product and moisture, become less easy to remove, and hence the image smearing becomes more liable to occur.

As a technology for ameliorating the image smearing, there is given a method involving incorporating metal oxide particles into the surface layer of the electrophotographic photosensitive member to control a volume resistivity of the surface layer of the electrophotographic photosensitive member.

On the surface of the electrophotographic photosensitive member, a dark portion potential is formed through application of a voltage from the charging member in the charging step. It is conceived that the charging for forming the dark portion potential is performed through two kinds of processes. One is a process in which the surface of the electrophotographic photosensitive member is charged by dielectric breakdown of an air layer between the charging member and the surface of the electrophotographic photosensitive member in accordance with Paschen's law. In the other process, when a contact potential difference between the electrophotographic photosensitive member and the charging member is sufficiently small, charging is performed through injection charging, in which a charge moves directly from the charging member to the electrophotographic photosensitive member in a contact portion between the charging member and the electrophotographic photosensitive member without discharge.

When the metal oxide particles are incorporated into the surface layer to control the volume resistivity, a ratio of the charging through the injection charging from the charging member to the electrophotographic photosensitive member in the charging step can be increased. That is, injection chargeability of the electrophotographic photosensitive member can be enhanced. Thus, the discharge can be suppressed, and hence the production of the discharge product can be suppressed.

In Japanese Patent Application Laid-Open No. 2002-214815, there is a description of a technology for enabling stable injection chargeability and prevention of flaws of an injection layer and image blurring even in repeated use by controlling the particle diameter of each of metal oxide particles that are electroconductive fine particles contained in a protection layer with respect to a toner particle diameter.

In addition, in Japanese Patent Application Laid-Open No. 2001-305775, there is a description of a technology for enabling image characteristics of high quality and stable injection charging even in repeated use by causing electroconductive particles in a protection layer to protrude by 0.2 μm or more from the surface of a photosensitive member.

In addition, in Japanese Patent Application Laid-Open No. 2009-229495, there is a description of a technology for enabling improvement of cleaning performance when an electrophotographic photosensitive member is used over a long period of time by incorporating a component obtained by subjecting a curable compound to a reaction and anatase-type titanium oxide containing a niobium atom into a protection layer (surface layer) of the electrophotographic photosensitive member.

According to investigations made by the inventors, in each of the technologies disclosed in Japanese Patent Application Laid-Open No. 2002-214815 and Japanese Patent Application Laid-Open No. 2001-305775, the configuration in which high injection chargeability is enabled by incorporating the metal oxide particles into the surface layer is used, but there has been a disadvantage in that a density at a low print percentage (highlight) cannot be obtained (hereinafter referred to as “highlight image smearing”) under a high-temperature and high-humidity environment. The highlight image smearing refers to a phenomenon in which, at a low print percentage, that is, in a reversal development system, a density is decreased when an exposure area at the time of a latent image is small as shown in FIG. 1.

The above-mentioned image smearing occurs due to the discharge product caused by discharge, whereas the highlight image smearing is a phenomenon that occurs from an initial stage of a developing step irrespective of the presence or absence of the production of the discharge product. Thus, it is conceived that the highlight image smearing is different from the above-mentioned image smearing in terms of occurrence mechanism.

### SUMMARY

Accordingly, an aspect of the present disclosure is to provide an electrophotographic photosensitive member capable of suppressing highlight image smearing even under a high-temperature and high-humidity environment while maintaining high injection chargeability. Another aspect of the present disclosure is to provide a process cartridge including the electrophotographic photosensitive member and an electrophotographic apparatus including the process cartridge.

The above-mentioned aspects are achieved by the following aspects of the present disclosure. That is, according to at least one aspect of the present disclosure, there is provided an electrophotographic photosensitive member including a surface layer containing a binder resin and metal oxide particles, wherein an average primary particle diameter of the metal oxide particles measured from a cross-section of the surface layer is 20 to 70 nm, and wherein a content ratio of the metal oxide particles in the surface layer measured from the cross-section of the surface layer is 30 to 75 vol % with respect to a total volume of the surface layer.

According to another aspect of the present disclosure, there is provided a process cartridge including: the above-mentioned electrophotographic photosensitive member; and at least one unit selected from the group consisting of: a charging unit; a developing unit; and a cleaning unit, the process cartridge integrally supporting the electrophotographic photosensitive member and the at least one unit, and being detachably attachable onto a main body of an electrophotographic apparatus.

According to still another aspect of the present disclosure, there is provided an electrophotographic apparatus including: the above-mentioned electrophotographic photosensitive member; and a charging unit, an exposing unit, a developing unit, and a transfer unit.

Further features of the present disclosure will become apparent from the following description of exemplary embodiments with reference to the attached drawings.

### BRIEF DESCRIPTION OF THE DRAWINGS

FIG. 1 is a graph for showing a relationship between a print percentage and a density for describing highlight image smearing.

FIG. 2 is a schematic view for illustrating an example of the configuration of an electrophotographic photosensitive member according to the present disclosure.

FIG. 3 is an image taken with a scanning transmission electron microscope (STEM) of an example of niobium-containing titanium oxide used in Examples of the present disclosure.

FIG. 4 is a schematic view of an example of niobium-containing titanium oxide used in Examples of the present disclosure.

FIG. 5 is a view for illustrating an example of comb-shaped electrodes to be used for the measurement of the volume resistivity of the electrophotographic photosensitive member.

FIG. 6 is a view for illustrating an example of the schematic configuration of a process cartridge including the electrophotographic photosensitive member according to the present disclosure and an electrophotographic apparatus including the process cartridge.

FIG. 7 is a view for illustrating a printing pattern of an image used in the evaluation of image fineness.

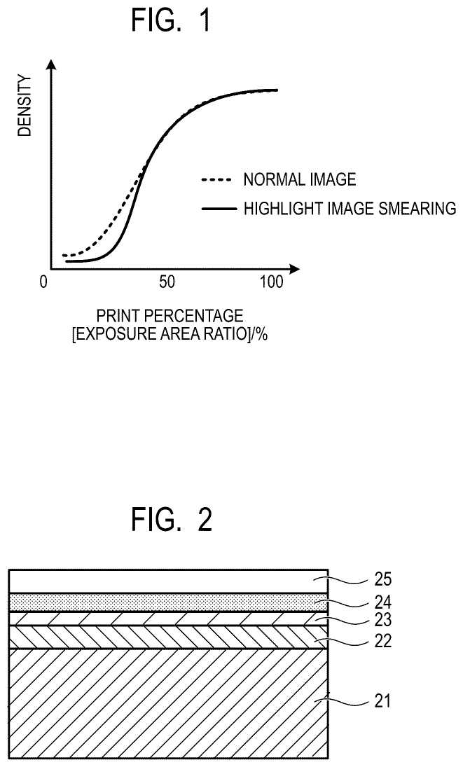

### DESCRIPTION OF THE EMBODIMENTS

The present disclosure is described in detail below by way of exemplary embodiments.

An electrophotographic photosensitive member according to at least one aspect of the present disclosure needs to be an electrophotographic photosensitive member including a surface layer containing a binder resin and metal oxide particles, wherein an average primary particle diameter of the metal oxide particles measured from a cross-section of the surface layer is 20 to 70 nm, and wherein a content ratio of the metal oxide particles in the surface layer measured from the cross-section of the surface layer is 30 to 75 vol % with respect to a total volume of the surface layer.

A process cartridge according to another aspect of the present disclosure integrally supports: the above-mentioned electrophotographic photosensitive member; and at least one unit selected from the group consisting of: a charging unit; a developing unit; and a cleaning unit, and is detachably attachable onto a main body of an electrophotographic apparatus.

An electrophotographic apparatus according to still another aspect of the present disclosure includes: the above-mentioned electrophotographic photosensitive member; and a charging unit, an exposing unit, a developing unit, and a transfer unit.

The development of high injection chargeability was able to be achieved by increasing the content ratio of the metal oxide particles in the surface layer, but highlight image smearing was deteriorated. Thus, there was a so-called trade-off relationship. The metal oxide particles serve as so-called charge injection points at which the metal oxide particles receive a charge through direct contact with a charging member, and hence it is conceived that the metal oxide particles can receive a larger amount of charge from the charging member when the content ratio of the metal oxide particles in the surface layer is increased. Meanwhile, when the content ratio of the metal oxide particles in the surface layer is increased, the metal oxide particles become continuous with each other, and the charge on the surface of the electrophotographic photosensitive member easily moves through the metal oxide particles. In particular, under a high-temperature and high-humidity environment, the surface layer absorbs moisture, the surface layer is decreased in resistance, and the charge movement is accelerated, and hence it is conceived that the highlight image smearing becomes remarkable under the high-temperature and high-humidity environment.

According to investigations made by the inventors, the reason why the electrophotographic photosensitive member according to the present disclosure, which adopts the above-mentioned unique configuration, suppresses the highlight image smearing while maintaining the high injection chargeability has been assumed as described below.

As described above, in order to maintain the high injection chargeability, it is required that the content ratio of the metal oxide particles in the surface layer be 30 to 75 vol % with respect to the total volume of the surface layer. This is because, when the content ratio of the metal oxide particles is less than 30 vol %, sufficient injection chargeability cannot be maintained, and when the content ratio of the metal oxide particles is more than 75 vol %, cracks are generated in the film of the surface layer due to the shortage of the binder resin, with the result that the strength as the film becomes weak, the metal oxide particles serving as the charge injection points are liable to be separated, and abrasion resistance is significantly decreased. The content ratio of the metal oxide particles in the surface layer is preferably 42 to 65 vol % with respect to the total volume of the surface layer.

Meanwhile, as a result of the investigations on the highlight image smearing, it has been found that the main factor for the highlight image smearing is the charge movement in the thickness direction of the surface layer. That is, in order to suppress the highlight image smearing, it is required to suppress the charge movement in the film of the surface layer. When the primary particle diameter of an electroconductive material is decreased, the interface area of each of the metal oxide particles (surface area of each of the particles) in the surface layer is increased. The binder resin enters the space between the metal oxide particles, and hence it is conceived that interface resistance is also increased along with an increase in interface area, resulting in suppression of the charge movement in the surface layer and suppression of the highlight image smearing.

When the primary particle diameter of the metal oxide particles is more than 70 nm, sufficient interface resistance is not obtained, and the suppression of the highlight image smearing cannot be expected. When the primary particle diameter of the metal oxide particles is less than 20 nm, the metal oxide particles are liable to be covered with the binder resin on the surface of the surface layer (protection layer), and the injection chargeability is lowered. The primary particle diameter of the metal oxide particles is preferably 30 to 60 nm.

A specific configuration of the electrophotographic photosensitive member according to the present disclosure is described below.

[Electrophotographic Photosensitive Member]

The electrophotographic photosensitive member of the present disclosure has a feature of including a photosensitive layer and a protection layer that is a surface layer.

FIG. 2 is a view for illustrating an example of the configuration of the electrophotographic photosensitive member according to the present disclosure. The electrophotographic photosensitive member illustrated in FIG. 2 includes a support 21, an undercoat layer 22, a charge-generating layer 23, a charge-transporting layer 24, and a protection layer 25 serving as a surface layer.

In FIG. 2, there is illustrated an example in which the photosensitive layer included in the electrophotographic photosensitive member is a laminate-type photosensitive layer formed of the charge-generating layer 23 and the charge-transporting layer 24. However, the photosensitive layer may be a monolayer-type photosensitive layer to be described later.

In addition, the electrophotographic photosensitive member may have a configuration that does not include the undercoat layer 22, and may have a configuration further including an electroconductive layer to be described later between the support 21 and the undercoat layer 22 or the photosensitive layer.

As a method of producing the electrophotographic photosensitive member of the present disclosure, there is given a method involving preparing coating liquids for the respective layers to be described later, applying the coating liquids in the desired order of layers onto the support, and drying the coating liquids. In this case, examples of a method of applying the coating liquid include dip coating, spray coating, inkjet coating, roll coating, die coating, blade coating, curtain coating, wire bar coating, and ring coating. Of those, dip coating is preferred from the viewpoints of efficiency and productivity.

The respective layers are described below.

<Protection layer (Surface Layer)>

The electrophotographic photosensitive member of the present disclosure includes, as the surface layer, a protection layer containing a binder resin and metal oxide particles. The protection layer contains 30 to 75 vol % of the metal oxide particles with respect to the total volume of the protection layer.

The protection layer may contain a charge-transporting substance.

It is preferred that the powder resistivity A (Ω·cm) of the metal oxide particles satisfy the following expression (1).

1.0×10³≤A≤1.0×10¹⁰ (1)

When the powder resistivity A of the metal oxide particles is lower than 1.0×10³ Ω·cm, the charge movement in the protection layer is difficult to suppress, and hence the highlight image smearing is deteriorated. In addition, when the powder resistivity A is more than 1.0×10¹⁰ Ω·cm, the injection chargeability is lowered. The powder resistivity A is more preferably 1.0×10⁵ to 1.0×10⁹ Ω·cm.

In the present disclosure, the powder resistivity A of the metal oxide particles is measured under a normal-temperature and normal-humidity (temperature: 23.0° C./relative humidity: 55%) environment. In the present disclosure, a resistivity meter Loresta-GP manufactured by Mitsubishi Chemical Corporation was used as a measuring apparatus. The metal oxide particles of the present disclosure to be measured were compacted at a pressure of 500 kg/cm² to form a pellet-shaped sample for measurement, and an applied voltage was set to 100 V.

Specific examples of the metal oxide particles include particles of metal oxides, such as titanium oxide, zinc oxide, tin oxide, and indium oxide. A metal oxide may be doped with elements, such as phosphorus and aluminum, or oxides thereof may be added to the metal oxide.

The metal oxide particles may each have a laminate configuration including a core particle and a covering layer that covers the core particle. Examples of the core particle include metal oxides, such as titanium oxide, barium sulfate, and zinc oxide. An example of the covering layer is a metal oxide such as tin oxide.

The metal oxide particles are particularly preferably niobium-containing titanium oxide particles.

Particles each having any of various shapes, such as a spherical shape, a polyhedral shape, an ellipsoidal shape, a flaky shape, and a needle shape, may be used as the niobium-containing titanium oxide particles. Of those, particles each having a spherical shape, a polyhedral shape, or an ellipsoidal shape are preferred from the viewpoint that image defects such as black spots are reduced. In the present disclosure, niobium-containing titanium oxide particles each having a spherical shape or a polyhedral shape close to a spherical shape are more preferred.

The niobium-containing titanium oxide particles are preferably anatase-type or rutile-type titanium oxide particles, and are more preferably anatase-type titanium oxide particles from the viewpoint of improving the injection chargeability.

In the present disclosure, the metal oxide particles are particularly preferably particles including anatase-type titanium oxide particles serving as a core and titanium oxide that covers the surface of the core and contains niobium. Niobium is preferably contained in titanium oxide in a so-called doped form in which niobium is incorporated into a crystal lattice of titanium oxide instead of being contained as an oxide. When titanium oxide is doped with niobium, the injection chargeability is enhanced.

When the metal oxide particles include niobium-containing titanium oxide particles, niobium in the metal oxide particles is incorporated in an amount of preferably 0.5 to 15.0 mass %, more preferably 2.6 to 10.0 mass %. When the content of niobium in the metal oxide particles is 0.5 mass % or more, the electroconductivity of titanium oxide can be increased, and the injection chargeability can be enhanced. When the content of niobium is 15.0 mass % or less, the crystal structure of titanium oxide can be maintained, and hence the volume resistivity of the protection layer does not become too large.

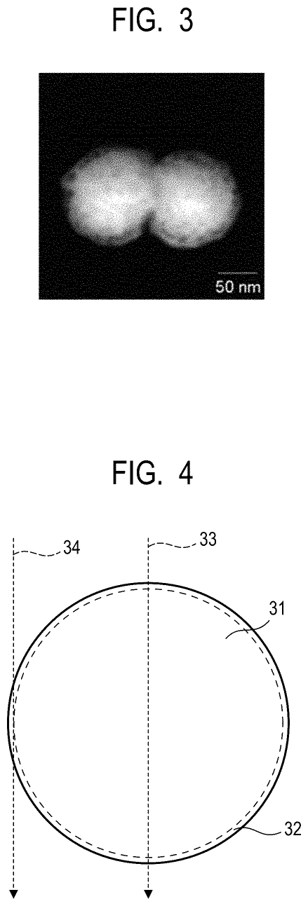

In addition, the metal oxide particles are particularly preferably titanium oxide particles each of which contains niobium and has a configuration in which niobium is localized in the vicinity of the surface of the particle. This is because the localization of niobium in the vicinity of the surface enables efficient transfer of a charge. More specifically, the metal oxide particles are titanium oxide particles in which a niobium/titanium atomic number ratio at an inside portion at 5% of a primary particle diameter from the surface of the metal oxide particle is 2.0 or more times as high as a niobium/titanium atomic number ratio at a center of the metal oxide particle in energy-dispersive X-ray spectroscopy (EDS) analysis with a scanning transmission electron microscope (STEM). In FIG. 3, there is shown a STEM image of an example of a metal oxide in which titanium oxide serving as a core is covered with niobium-containing titanium oxide in the same manner as in titanium oxide particles (metal oxide particles 1) used in Examples of the present disclosure. In addition, the STEM image of FIG. 3 is schematically illustrated in FIG. 4. As described in detail later, niobium-containing titanium oxide particles used in Examples of the present disclosure are produced by covering titanium oxide particles serving as a core with niobium-containing titanium oxide, and then firing the resultant. Accordingly, the covering niobium-containing titanium oxide is conceived to undergo crystal growth as niobium-doped titanium oxide through so-called epitaxial growth along a crystal of the titanium oxide serving as a core. As shown in FIG. 3, the thus produced niobium-containing titanium oxide has a lower density in the vicinity of the surface than at the central portion of the particle, and hence is conceived to have a core-shell-like form. In addition, in the EDS analysis with the STEM, an X-ray penetrates the entire particle, and hence the influence in the vicinity of the surface becomes large in the EDS analysis at an inside portion at 5% of a primary particle diameter from the surface of the particle as indicated in a direction of 34 as compared to the EDS analysis at a central portion of the particle as indicated in a direction of 33 as illustrated in FIG. 4. That is, it is conceived that a state in which a niobium/titanium atomic number ratio at an inside portion at 5% of a primary particle diameter from the surface of the particle is 2.0 or more times as high as a niobium/titanium atomic number ratio at a center of the particle in the EDS analysis with the STEM as described above corresponds to a state in which a niobium element is localized in the vicinity of the surface. In FIG. 4, there are illustrated a region 32 of the metal oxide particle at an inside portion at 5% of a primary particle diameter from the surface of the particle and a region 31 of the metal oxide particle on an inner side from the region 32. In addition, there are illustrated an X-ray 33 for analyzing a central portion of the metal oxide particle, and an X-ray 34 for analyzing an inside portion at 5% of a primary particle diameter from the surface of the metal oxide particle.

The EDS analysis with the STEM involves observation with the transmission electron microscope and measurement of the niobium/titanium ratios by EDS. In addition, the niobium/titanium ratios may be directly measured from the electrophotographic photosensitive member by slicing the electrophotographic photosensitive member through use of a microtome, Ar milling, FIB, or the like.

In addition, it is preferred that the niobium-containing titanium oxide particles to be incorporated into the protection layer have oxygen deficiency. When the niobium-containing titanium oxide particles have oxygen deficiency, the injection chargeability is improved. The detailed mechanism is not well understood, but it is assumed that, when the niobium-containing titanium oxide particles have oxygen deficiency, the particles can easily receive a charge, and hence the injection chargeability is improved. The oxygen deficiency rate of each of the niobium-containing titanium oxide particles is preferably 0.1 to 2.0%. When the oxygen deficiency rate is less than 0.1%, the improvement in injection chargeability cannot be expected. When the oxygen deficiency rate is more than 2.0%, the tint of the particle becomes black, and the transparency of the protection layer is decreased, leading to a decrease in sensitivity of the electrophotographic photosensitive member. In addition, when the oxygen deficiency rate in a region at 5% or less of a primary particle diameter from the surface of the niobium-containing titanium oxide particle is represented by β, and the oxygen deficiency rate in a region except the above-mentioned region is represented by γ, it is preferred that the following expression (α) be satisfied.

β>10×γ (α)

This is because injection charging can be effectively performed when the oxygen-deficient portion that makes it easier to receive a charge is localized on the surface of the metal oxide particle.

The oxygen deficiency rate of the metal oxide particle, and the ratio between the oxygen deficiency rate in the region at 5% or less of a primary particle diameter from the surface of the metal oxide particle and the oxygen deficiency rate in the region except the above-mentioned region may each be measured by the energy-dispersive X-ray spectroscopy (EDS) analysis. In addition, as described above, in the EDS analysis, an X-ray penetrates the entire particle, and hence the satisfaction of the above-mentioned expression (α) means that the oxygen-deficient portion is localized in the vicinity of the surface of the particle.

In the present disclosure, the ratio between the oxygen deficiency rate in the region at 5% or less of a primary particle diameter from the surface of the metal oxide particle and the oxygen deficiency rate in the region except the above-mentioned region was measured by the STEM-EDS analysis on the metal oxide particle.

Oxygen deficiency may be introduced by firing the metal oxide particles under a reducing atmosphere of, for example, ammonia or hydrogen or firing the metal oxide particles at 600° C. or more that is the decomposition temperature of an organic substance under a nitrogen atmosphere together with the organic substance.

The detailed mechanism is not clear, but as described above, it is conceived that the reason for the enhancement of the injection chargeability by doping with niobium or introduction of oxygen deficiency is that a charge is easily transferred from electroconductive particles, such as carbon black and graphite, which are generally used for the charging member, and the movement of the charge from the charging member to the electrophotographic photosensitive member is facilitated.

In addition, the metal oxide particles are each surface-treated with a compound having a silicon atom, such as a silane coupling agent or a silicone resin. The surface treatment enhances the hydrophobicity of the metal oxide particles. In addition, when the interface resistance between the metal oxide particles, which suppresses the uneven dispersion of the metal oxide particles in the protection layer, is kept high by the surface treatment, a decrease in resistance associated with the poor dispersion in the surface layer is suppressed. As a result, the surface layer under a high-humidity environment is kept at high resistance, and hence the highlight image smearing can be suppressed.

The compound having a silicon atom to be used for the surface treatment of the metal oxide particles preferably contains an alkyl group having 12 or less carbon atoms.

A silane coupling agent is suitably used for the surface treatment of the metal oxide particles. A compound represented by the following formula (A) may be used as the silane coupling agent.

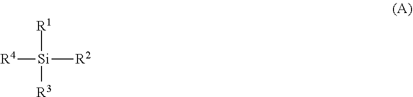

In the formula (A), R¹ to R³ each independently represent an alkoxy group or an alkyl group, provided that at least two of R¹ to R³ represent alkoxy groups. R⁴ represents an alkyl group having 12 or less carbon atoms.

Examples of the compound represented by the formula (A) include hexyltrimethoxysilane, hexyltriethoxysilane, octyltrimethoxysilane, octyltriethoxysilane, decyltrimethoxysilane, dodecyltrimethoxysilane, and dodecyltriethoxysilane.

In addition, as the silane coupling agent, a silane coupling agent except the compound represented by the formula (A), such as N-2-(aminoethyl)-3-aminopropylmethyldimethoxysilane, 3-aminopropylmethyldiethoxysilane, (phenylaminomethyl)methyldimethoxysilane, N-2-(aminoethyl)-3-aminoisobutylmethyldimethoxysilane, N-ethylaminoisobutylmethyldiethoxysilane, N-methylaminopropylmethyldimethoxysilane, vinyltrimethoxysilane, 3-aminopropyltriethoxysilane, N-(2-aminoethyl)-3-aminopropyltrimethoxysilane, methyltrimethoxysilane, 3-glycidoxypropyltrimethoxysilane, 3-methacryloxypropyltrimethoxysilane, 3-chloropropyltrimethoxysilane, or 3-mercaptopropyltrimethoxysilane, may be used in combination with the compound represented by the formula (A).

A general method is used as a method of surface-treating the metal oxide particles. Examples thereof include a dry method and a wet method.

The dry method involves, while stirring the metal oxide particles in a mixer capable of high-speed stirring such as a Henschel mixer, adding an alcoholic aqueous solution, organic solvent solution, or aqueous solution containing the surface treatment agent, uniformly dispersing the mixture, and then drying the dispersion.

In addition, the wet method involves stirring the metal oxide particles and the surface treatment agent in a solvent, or dispersing the metal oxide particles and the surface treatment agent in a solvent with a sand mill or the like using glass beads or the like. After the dispersion, the solvent is removed by filtration or evaporation under reduced pressure. After the removal of the solvent, it is preferred to further perform baking at 100° C. or more.

Examples of the charge-transporting substance include a polycyclic aromatic compound, a heterocyclic compound, a hydrazone compound, a styryl compound, an enamine compound, a benzidine compound, a triarylamine compound, and a resin having a group derived from each of those substances. Of those, a triarylamine compound and a benzidine compound are preferred.

The thickness of the protection layer serving as the surface layer is preferably 0.1 to 2.0 μm. When the thickness of the protection layer is less than 0.1 μm, it becomes difficult for the surface layer containing the metal oxide particles to cover the entire surface of the electrophotographic photosensitive member, and the injection chargeability is lowered. In addition, when the thickness of the protection layer is more than 1.0 μm, a shared voltage is increased, the charge gets into the protection layer, and the highlight image smearing is deteriorated. The thickness is more preferably 0.1 to 1.5 μm.

It is preferred that the volume resistivity B (Ω·cm) of the binder resin, which is used for the protection layer serving as the surface layer, at a temperature of 32.5° C. and a humidity of 80% RH (hereinafter sometimes referred to as “HH environment”) satisfy the following expression (4).

1.0×10¹²≤B≤1.0×10¹⁵ (4)

Although the metal oxide particles exist in the surface layer at a high content ratio, the binder resin enters the space between the metal oxide particles at a high probability. Thus, when the volume resistivity B of the binder resin is high, the charge movement in the surface layer described above can be suppressed, and the highlight image smearing is suppressed. When the volume resistivity B of the binder resin is less than 1.0×10¹² Ω·cm, the above-mentioned effect cannot be exhibited, and the highlight image smearing cannot be sufficiently suppressed.

Specific examples of the binder resin to be used in the present disclosure include a polyester resin, an acrylic resin, a phenoxy resin, a polycarbonate resin, a polyarylate resin, a polystyrene resin, a phenol resin, a melamine resin, and an epoxy resin. Of those, at least one resin selected from the group consisting of: a polycarbonate resin; a polyarylate resin; and an acrylic resin is preferably incorporated.

In addition, the protection layer may be formed as a cured film by polymerizing a composition containing a monomer having a polymerizable functional group. A reaction in this case is, for example, a thermal polymerization reaction, a photopolymerization reaction, or a radiation polymerization reaction. Examples of the polymerizable functional group of the monomer having a polymerizable functional group include an acryloyl group and a methacryloyl group. A material having a charge-transporting ability may be used as the monomer having a polymerizable functional group.

In addition, the protection layer may contain a resin having a silicon atom.

An example of the resin having a silicon atom that may be incorporated into the protection layer is a silicone oil. Examples of the silicone oil include a straight silicone oil and a modified silicone oil. Examples of the straight silicone oil include a dimethyl silicone oil, a methyl phenyl silicone oil, and a methyl hydrogen silicone oil. Examples of the modified silicone oil include: reactive silicone oils, such as amino-modified, epoxy-modified, carboxy-modified, carbinol-modified, methacryl-modified, mercapto-modified, and phenol-modified silicone oils; and non-reactive silicone oils, such as polyether-modified, methyl styryl-modified, alkyl-modified, ester-modified, and fluorine-modified silicone oils. Further, a block polymer or graft polymer having a polydimethylsiloxane structure introduced into a side chain or main chain thereof may be used as the resin having a silicon atom.

The protection layer may contain an additive, such as an antioxidant, a UV absorber, a plasticizer, a leveling agent, a slipperiness-imparting agent, or an abrasion resistance-improving agent. Specific examples thereof include a hindered phenol compound, a hindered amine compound, a sulfur compound, a phosphorus compound, a benzophenone compound, a siloxane-modified resin, a silicone oil, fluororesin particles, polystyrene resin particles, polyethylene resin particles, silica particles, alumina particles, and boron nitride particles.

In addition, it is preferred that the volume resistivity C (Ω·cm) of the protection layer serving as the surface layer at a temperature of 32.5° C. and a humidity of 80% RH (HH environment) satisfy the following expression (2).

1.0×10¹¹≤C≤1.0×10¹³ (2)

When the volume resistivity C of the protection layer is less than 1.0×10¹¹ Ω·cm, the potential distribution of a latent image cannot be maintained, and the latent image collapses, with the result that the highlight image smearing cannot be suppressed. The volume resistivity C is more preferably 7.0×10¹¹ to 1.0×10¹³ Ω·cm.

In addition, it is preferred that the volume resistivity D (Ω·cm) of the protection layer at a temperature of 23.0° C. and a humidity of 55% RH (hereinafter sometimes referred to as “NN environment”) satisfy the following expression (3).

1.0×10¹²≤D≤1.0 ×10¹⁴ (3)

When the volume resistivity D of the protection layer is less than 1.0×10¹² Ω·cm, the risk of leakage is increased.

Further, it is preferred that the volume resistivity C (Ω·cm) of the protection layer serving as the surface layer at a temperature of 32.5° C. and a humidity of 80% RH and the volume resistivity D (Ω·cm) of the protection layer serving as the surface layer at a temperature of 23.0° C. and a humidity of 55% RH satisfy the following expression (5).

0.05≤D/C≤1.0 (5)

When the volume resistivities C and D of the protection layer serving as the surface layer satisfy the relationship of the expression (5), the charge movement in the surface layer can be suppressed, and the highlight image smearing is suppressed.

The volume resistivity of the protection layer and the binder resin may be measured as described below.

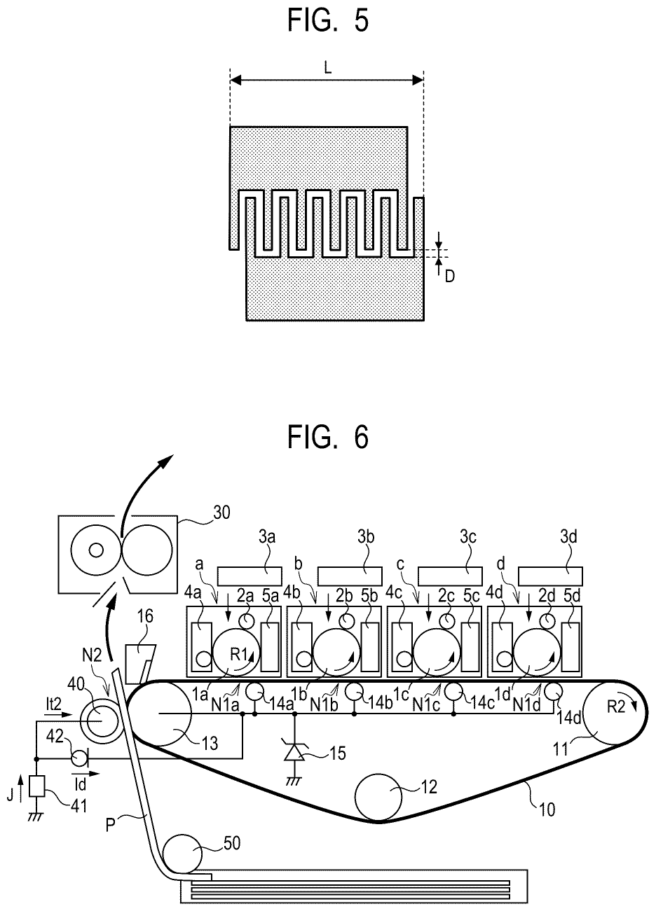

A picoampere (pA) meter is used for the measurement of the volume resistivity. First, such comb-shaped gold electrodes having an electrode-to-electrode distance (D) of 180 m and a length (L) of 59 mm as illustrated in FIG. 5 are produced on a PET film by gold vapor deposition. A protection layer and a binder resin having a thickness (T1) of 2 μm is formed on the produced comb-shaped gold electrodes so as to cover the comb-shaped gold electrodes. Next, under each of an environment having a temperature of 23.0° C. and a humidity of 55% RH (NN) and an environment having a temperature of 32.5° C. and a humidity of 80% RH (HH), a DC current (I) at the time of the application of a DC voltage (V) of 100 V between the comb-shaped gold electrodes is measured. Through use of the resultant measurement values, a volume resistivity C (temperature: 32.5° C./humidity: 80% RH) and a volume resistivity D (temperature: 23.0° C./humidity: 55% RH) are obtained by the following expression (6).

Volume resistivity ρv (Ω·cm)=V(V)×T1 (cm)×L (cm)/{I(A)×D (cm)} (6)

When the composition, including the metal oxide particles, the binder resin, and the like, of the protection layer is difficult to identify, the surface resistivity of the surface of the electrophotographic photosensitive member is measured and converted into the volume resistivity. That is, when the volume resistivity of not the protection layer alone, but the protection layer existing as the surface layer of the electrophotographic photosensitive member is measured, the surface resistivity of the protection layer is measured, and the resultant value is converted into the volume resistivity.

Specifically, such comb-shaped gold electrodes having an electrode-to-electrode distance (D) of 180 μm and a length (L) of 59 mm as illustrated in FIG. 5 are produced on the surface of the electrophotographic photosensitive member (surface of the protection layer) by gold vapor deposition. Next, under each of an environment having a temperature of 23.0° C. and a humidity of 55% RH (NN) and an environment having a temperature of 32.5° C. and a humidity of 80% RH (HH), a DC current (I) at the time of the application of a DC voltage (V) of 1,000 V between the comb-shaped gold electrodes is measured, and the surface resistivity ρs of the protection layer is calculated from DC voltage (V)/DC current (I).

The volume resistivity may be obtained by the following expression (7) through use of the resultant surface resistivity ρs and the thickness “t” (cm) of the protection layer.

ρv=ρs×t (7)

(ρv: volume resistivity, ρs: surface resistivity, t: thickness of protection layer)

This measurement involves measuring a minute current amount, and hence is preferably performed using, as a resistance-measuring apparatus, an instrument capable of measuring a minute current. An example of the resistance-measuring apparatus capable of measuring a minute current is a picoammeter 4140B manufactured by Hewlett-Packard Company. The comb-shaped electrodes to be used and the voltage to be applied are preferably selected in accordance with the material and resistance value of the protection layer so that an appropriate SN ratio may be obtained.

The protection layer may be formed by preparing a coating liquid for a protection layer containing the above-mentioned materials and a solvent, forming a coat thereof on the photosensitive layer, and drying and/or curing the coat. Examples of the solvent to be used for the coating liquid include an alcohol-based solvent, a ketone-based solvent, an ether-based solvent, a sulfoxide-based solvent, an ester-based solvent, and an aromatic hydrocarbon-based solvent.

<Support>

In the present disclosure, the electrophotographic photosensitive member may include a support. In the present disclosure, the support is preferably an electroconductive support having electroconductivity. In addition, examples of the shape of the support include a cylindrical shape, a belt shape, and a sheet shape. Of those, a cylindrical support is preferred. In addition, the surface of the support may be subjected to, for example, electrochemical treatment such as anodization, blast treatment, or cutting treatment.

A metal, a resin, glass, or the like is preferred as a material for the support.

Examples of the metal include aluminum, iron, nickel, copper, gold, stainless steel, and alloys thereof Of those, an aluminum support using aluminum is preferred.

In addition, electroconductivity may be imparted to the resin or the glass through treatment involving, for example, mixing or coating with an electroconductive material.

<Electroconductive Layer>

In the present disclosure, an electroconductive layer may be arranged on the support. The arrangement of the electroconductive layer can conceal flaws and unevenness in the surface of the support, and control the reflection of light on the surface of the support.

The electroconductive layer preferably contains electroconductive particles and a resin.

A material for the electroconductive particles is, for example, a metal oxide, a metal, or carbon black.

Examples of the metal oxide include zinc oxide, aluminum oxide, indium oxide, silicon oxide, zirconium oxide, tin oxide, titanium oxide, magnesium oxide, antimony oxide, and bismuth oxide. Examples of the metal include aluminum, nickel, iron, nichrome, copper, zinc, and silver.

Of those, the metal oxide is preferably used as the electroconductive particles, and in particular, titanium oxide, tin oxide, and zinc oxide are more preferably used.

When the metal oxide is used as the electroconductive particles, the surface of the metal oxide may be treated with a silane coupling agent or the like, or the metal oxide may be doped with an element, such as phosphorus or aluminum, or an oxide thereof.

In addition, the electroconductive particles may each have a laminate configuration including a core particle and a covering layer that covers the core particle. Examples of the core particle include titanium oxide, barium sulfate, and zinc oxide. An example of the covering layer is a metal oxide such as tin oxide.

In addition, when the metal oxide is used as the electroconductive particles, their volume-average particle diameter is preferably 1 to 500 nm, more preferably 3 to 400 nm.

Examples of the resin include a polyester resin, a polycarbonate resin, a polyvinyl acetal resin, an acrylic resin, a silicone resin, an epoxy resin, a melamine resin, a polyurethane resin, a phenol resin, and an alkyd resin.

In addition, the electroconductive layer may further contain a concealing agent, such as a silicone oil, resin particles, or titanium oxide.

The electroconductive layer has an average thickness of preferably 1 to 50 m, particularly preferably 3 to 40 m.

The electroconductive layer may be formed by preparing a coating liquid for an electroconductive layer containing the above-mentioned materials and a solvent, forming a coat thereof on the support, and drying the coat. Examples of the solvent to be used for the coating liquid include an alcohol-based solvent, a sulfoxide-based solvent, a ketone-based solvent, an ether-based solvent, an ester-based solvent, and an aromatic hydrocarbon-based solvent. A dispersion method for dispersing the electroconductive particles in the coating liquid for an electroconductive layer is, for example, a method involving using a paint shaker, a sand mill, a ball mill, or a liquid collision-type high-speed disperser.

<Undercoat Layer>

In the present disclosure, an undercoat layer may be arranged on the support or the electroconductive layer. The arrangement of the undercoat layer can improve an adhesive function between layers to impart an injection charging-inhibiting function.

The undercoat layer preferably contains a resin. In addition, the undercoat layer may be formed as a cured film by polymerizing a composition containing a monomer having a polymerizable functional group.

Examples of the resin include a polyester resin, a polycarbonate resin, a polyvinyl acetal resin, an acrylic resin, an epoxy resin, a melamine resin, a polyurethane resin, a phenol resin, a polyvinyl phenol resin, an alkyd resin, a polyvinyl alcohol resin, a polyethylene oxide resin, a polypropylene oxide resin, a polyamide resin, a polyamic acid resin, a polyimide resin, a polyamide imide resin, and a cellulose resin.

Examples of the polymerizable functional group of the monomer having a polymerizable functional group include an isocyanate group, a blocked isocyanate group, a methylol group, an alkylated methylol group, an epoxy group, a metal alkoxide group, a hydroxyl group, an amino group, a carboxyl group, a thiol group, a carboxylic acid anhydride group, and a carbon-carbon double bond group.

In addition, the undercoat layer may further contain an electron-transporting substance, a metal oxide, a metal, an electroconductive polymer, and the like for the purpose of improving electric characteristics. Of those, an electron-transporting substance and a metal oxide are preferably used.

Examples of the electron-transporting substance include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-containing compound. An electron-transporting substance having a polymerizable functional group may be used as the electron-transporting substance and copolymerized with the above-mentioned monomer having a polymerizable functional group to form the undercoat layer as a cured film.

Examples of the metal oxide include indium tin oxide, tin oxide, indium oxide, titanium oxide, zinc oxide, aluminum oxide, and silicon dioxide. Examples of the metal include gold, silver, and aluminum.

The metal oxide particles to be incorporated into the undercoat layer may be surface-treated with a surface treatment agent such as a silane coupling agent before use. A general method is used as a method of surface-treating the metal oxide particles. Examples thereof include a dry method and a wet method.

The dry method involves, while stirring the metal oxide particles in a mixer capable of high-speed stirring such as a Henschel mixer, adding an alcoholic aqueous solution, organic solvent solution, or aqueous solution containing the surface treatment agent, uniformly dispersing the mixture, and then drying the dispersion.

In addition, the wet method involves stirring the metal oxide particles and the surface treatment agent in a solvent, or dispersing the metal oxide particles and the surface treatment agent in a solvent with a sand mill or the like using glass beads or the like. After the dispersion, the solvent is removed by filtration or evaporation under reduced pressure. After the removal of the solvent, it is preferred to further perform baking at 100° C. or more.

The undercoat layer may further contain an additive, and for example, may contain a known material, such as: powder of a metal such as aluminum; an electroconductive substance such as carbon black; a charge-transporting substance; a metal chelate compound; or an organometallic compound.

Examples of the charge-transporting substance include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-containing compound. A charge-transporting substance having a polymerizable functional group may be used as the charge-transporting substance and copolymerized with the above-mentioned monomer having a polymerizable functional group to form the undercoat layer as a cured film.

The undercoat layer may be formed by preparing a coating liquid for an undercoat layer containing the above-mentioned materials and a solvent, forming a coat thereof on the support or the electroconductive layer, and drying and/or curing the coat.

Examples of the solvent to be used for the coating liquid for an undercoat layer include organic solvents, such as an alcohol, a sulfoxide, a ketone, an ether, an ester, an aliphatic halogenated hydrocarbon, and an aromatic compound. In the present disclosure, alcohol-based and ketone-based solvents are preferably used.

A dispersion method for preparing the coating liquid for an undercoat layer is, for example, a method involving using a homogenizer, an ultrasonic disperser, a ball mill, a sand mill, a roll mill, a vibration mill, an attritor, or a liquid collision-type high-speed disperser.

The undercoat layer has an average thickness of preferably 0.1 to 50 m, more preferably 0.2 to 40 m, particularly preferably 0.3 to 30 m.

<Photosensitive Layer>

The photosensitive layers of the electrophotographic photosensitive member are mainly classified into (1) a laminate-type photosensitive layer and (2) a monolayer-type photosensitive layer. (1) The laminate-type photosensitive layer has a charge-generating layer containing a charge-generating substance and a charge-transporting layer containing a charge-transporting substance. (2) The monolayer-type photosensitive layer is a photosensitive layer containing both a charge-generating substance and a charge-transporting substance.

(1) Laminate-Type Photosensitive Layer

The laminate-type photosensitive layer has the charge-generating layer and the charge-transporting layer.

(1-1) Charge-Generating Layer

The charge-generating layer preferably contains the charge-generating substance and a resin.

Examples of the charge-generating substance include azo pigments, perylene pigments, polycyclic quinone pigments, indigo pigments, and phthalocyanine pigments. Of those, azo pigments and phthalocyanine pigments are preferred. Of the phthalocyanine pigments, an oxytitanium phthalocyanine pigment, a chlorogallium phthalocyanine pigment, and a hydroxygallium phthalocyanine pigment are preferred.

The content of the charge-generating substance in the charge-generating layer is preferably 40 to 85 mass %, more preferably 60 to 80 mass % with respect to the total mass of the charge-generating layer.

Examples of the resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin, and a polyvinyl chloride resin. Of those, a polyvinyl butyral resin is more preferred.

In addition, the charge-generating layer may further contain an additive, such as an antioxidant or a UV absorber. Specific examples thereof include a hindered phenol compound, a hindered amine compound, a sulfur compound, a phosphorus compound, and a benzophenone compound.

The charge-generating layer has an average thickness of preferably 0.1 to 1.0 μm, more preferably 0.15 to 0.4 μm.

The charge-generating layer may be formed by preparing a coating liquid for a charge-generating layer containing the above-mentioned materials and a solvent, forming a coat thereof on the support or the electroconductive layer or the undercoat layer, and drying the coat. Examples of the solvent to be used for the coating liquid include an alcohol-based solvent, a sulfoxide-based solvent, a ketone-based solvent, an ether-based solvent, an ester-based solvent, and an aromatic hydrocarbon-based solvent.

(1-2) Charge-Transporting Layer

The charge-transporting layer preferably contains the charge-transporting substance and a resin.

Examples of the charge-transporting substance include a polycyclic aromatic compound, a heterocyclic compound, a hydrazone compound, a styryl compound, an enamine compound, a benzidine compound, a triarylamine compound, and a resin having a group derived from each of those substances. Of those, a triarylamine compound and a benzidine compound are preferred.

The content of the charge-transporting substance in the charge-transporting layer is preferably 25 to 70 mass %, more preferably 30 to 55 mass % with respect to the total mass of the charge-transporting layer.

Examples of the resin include a polyester resin, a polycarbonate resin, an acrylic resin, and a polystyrene resin. Of those, a polycarbonate resin and a polyester resin are preferred. A polyarylate resin is particularly preferred as the polyester resin.

A content ratio (mass ratio) between the charge-transporting substance and the resin is preferably from 4:10 to 20:10, more preferably from 5:10 to 12:10.

In addition, the charge-transporting layer may contain an additive, such as an antioxidant, a UV absorber, a plasticizer, a leveling agent, a slipperiness-imparting agent, or an abrasion resistance-improving agent. Specific examples thereof include a hindered phenol compound, a hindered amine compound, a sulfur compound, a phosphorus compound, a benzophenone compound, a siloxane-modified resin, a silicone oil, fluororesin particles, polystyrene resin particles, polyethylene resin particles, silica particles, alumina particles, and boron nitride particles.

The charge-transporting layer has an average thickness of 5 to 50 μm, more preferably 8 to 40 μm, particularly preferably 9 to 30 μm.

The charge-transporting layer may be formed by preparing a coating liquid for a charge-transporting layer containing the above-mentioned materials and a solvent, forming a coat thereof on the charge-generating layer, and drying the coat. Examples of the solvent to be used for the coating liquid include an alcohol-based solvent, a ketone-based solvent, an ether-based solvent, an ester-based solvent, and an aromatic hydrocarbon-based solvent. Of those solvents, an ether-based solvent or an aromatic hydrocarbon-based solvent is preferred.

(2) Monolayer-Type Photosensitive Layer

The monolayer-type photosensitive layer may be formed by preparing a coating liquid for a photosensitive layer containing the charge-generating substance, the charge-transporting substance, a resin, and a solvent, forming a coat thereof, and drying the coat. Examples of the charge-generating substance, the charge-transporting substance, and the resin are the same as those of the materials in the section “(1) Laminate-type Photosensitive Layer.”

[Process Cartridge and Electrophotographic Apparatus]

A process cartridge of the present disclosure has a feature of integrally supporting the electrophotographic photosensitive member described in the foregoing, and at least one unit selected from the group consisting of: a charging unit; a developing unit; a transfer unit; and a cleaning unit, and being detachably attachable onto the main body of an electrophotographic apparatus.

In addition, an electrophotographic apparatus of the present disclosure has a feature of including: the electrophotographic photosensitive member described in the foregoing; a charging unit; an exposing unit; a developing unit; and a transfer unit.

An example of the schematic configuration of an electrophotographic apparatus including a process cartridge including an electrophotographic photosensitive member is illustrated in FIG. 6.

[Configuration of Electrophotographic Apparatus]

An electrophotographic apparatus of this example is a so-called tandem-type electrophotographic apparatus provided with a plurality of image forming portions “a” to “d”. A first image forming portion “a” forms an image with a toner of yellow (Y). A second image forming portion “b” forms an image with a toner of magenta (M). A third image forming portion “c” forms an image with a toner of cyan (C). A fourth image forming portion “d” forms an image with a toner of black (Bk). Those four image forming portions are arranged in a row at constant intervals, and the configurations of the respective image forming portions are substantially the same in many respects except the color of a toner to be stored. Thus, the electrophotographic apparatus of this example is described below through use of the first image forming portion “a”.

The first image forming portion “a” includes a photosensitive drum 1a that is a drum-shaped electrophotographic photosensitive member, a charging roller 2a that is a charging member, a developing unit 4a, and a drum cleaning unit 5a.

The photosensitive drum 1a is an image-bearing member that bears a toner image, and is rotationally driven in a direction indicated by the arrow R1 illustrated in the figure at a predetermined peripheral speed (process speed). The developing unit 4a stores a yellow toner and develops the yellow toner on the photosensitive drum 1a. The drum cleaning unit 5a is a unit for recovering a toner adhering to the photosensitive drum 1a. The drum cleaning unit 5a includes a cleaning blade that is brought into contact with the photosensitive drum 1a and a waste toner box that stores, for example, a toner removed from the photosensitive drum 1a with the cleaning blade.

An image forming operation is started when a control unit (not shown) such as a controller receives an image signal, and the photosensitive drum 1a is rotationally driven. During the rotation process, the photosensitive drum 1a is uniformly charged to a predetermined voltage (charging voltage) with a predetermined polarity (negative polarity in this example) by the charging roller 2a, and is exposed by an exposing unit 3a in accordance with the image signal. Thus, an electrostatic latent image corresponding to a yellow color component image of a target color image is formed on the photosensitive drum 1a. Then, the electrostatic latent image is developed by the developing unit 4a at a developing position and visualized as a yellow toner image on the photosensitive drum 1a. Here, the normal charging polarity of the toner stored in the developing unit 4a is a negative polarity, and the electrostatic latent image is subjected to reversal development with the toner charged to the same polarity as the charging polarity of the photosensitive drum 1a by the charging roller 2a. However, the present disclosure is not limited thereto, and the present disclosure may be applied also to an electrophotographic apparatus in which an electrostatic latent image is subjected to normal development with a toner charged to a polarity opposite to the charging polarity of the photosensitive drum 1a.

An endless and movable intermediate transfer belt 10 has electroconductivity. The intermediate transfer belt 10 is brought into contact with the photosensitive drum 1a to form a primary transfer portion N1a, and is rotated at substantially the same peripheral speed as that of the photosensitive drum 1a. In addition, the intermediate transfer belt 10 is tensioned by a counter roller 13 serving as a counter member, a drive roller 11 and a tension roller 12 each serving as a tension member, and a metal roller 14a, and is tensioned by the tension roller 12 under a tension of a total pressure of 60 N. The intermediate transfer belt 10 can be moved when the drive roller 11 is rotationally driven in a direction indicated by the arrow R2 illustrated in the figure. In addition, each metal roller 14 and the counter roller 13 are connected to ground through a Zener diode 15 serving as a constant voltage element.

The yellow toner image formed on the photosensitive drum 1a is primarily transferred from the photosensitive drum 1a to the intermediate transfer belt 10 in the process of passing through the primary transfer portion N1a. The primary transfer residual toner remaining on the surface of the photosensitive drum 1a is cleaned and removed by the drum cleaning unit 5a, and then is subjected to an image forming process after the charging.

During the primary transfer, a current is supplied to the electroconductive intermediate transfer belt 10 from a secondary transfer roller 40 serving as a secondary transfer member that is brought into contact with an outer peripheral surface of the intermediate transfer belt 10. When the current supplied from the secondary transfer roller 40 flows in a peripheral direction of the intermediate transfer belt 10, the toner image is primarily transferred from the photosensitive drum 1a to the intermediate transfer belt 10. In this case, a voltage having a predetermined polarity (positive polarity in this example) opposite to the normal charging polarity of the toner is applied to the secondary transfer roller 40 in a direction indicated by the arrow J from a transfer power source 41.

Subsequently, a magenta toner image of the second color, a cyan toner image of the third color, and a black toner image of the fourth color are formed in the same manner, and are sequentially transferred onto the intermediate transfer belt 10 so as to be superimposed on one another. Thus, toner images of four colors corresponding to target color images are formed on the intermediate transfer belt 10. After that, the toner images of the four colors borne on the intermediate transfer belt 10 are secondarily transferred in a batch onto the surface of a transfer material P, such as paper or an OHP sheet, fed by a sheet feeding unit 50 in the process of passing through a secondary transfer portion N2 formed by the contact between the secondary transfer roller 40 and the intermediate transfer belt 10. The transfer material P having the toner images of the four colors transferred thereto by secondary transfer is then heated and pressurized in a fixing unit 30, and the toners of the four colors are melted and mixed to be fixed onto the transfer material P. The toner remaining on the intermediate transfer belt 10 after the secondary transfer is cleaned and removed by a belt cleaning unit 16 arranged so as to be opposed to the counter roller 13 through intermediation of the intermediate transfer belt 10. In addition, a path not involving the secondary transfer roller 40 is formed, in which the transfer power source 41 and each metal roller 14 are electrically connected through a constant current diode 42 serving as a constant current element. In addition, when a voltage is applied from the transfer power source 41 to the secondary transfer roller 40, a pinch-off current Id flows through the constant current diode 42 separately from a current It2 flowing toward the secondary transfer portion N2.

In FIG. 6, there are illustrated photosensitive drums 1b, 1c, and Id that are drum-shaped electrophotographic photosensitive members, charging rollers 2b, 2c, and 2d serving as charging units, exposing units 3b, 3c, and 3d, developing units 4b, 4c, and 4d, cleaning units 5b, 5c, and 5d, and primary transfer portions N1b, N1c, and N1d.

The electrophotographic photosensitive member of the present disclosure can be used in, for example, a laser beam printer, an LED printer, a copying machine, a facsimile, and a multifunctional peripheral thereof.

### EXAMPLES

The present disclosure is described in more detail below by way of Examples and Comparative Examples. The present disclosure is by no means limited to the following Examples, and various modifications may be made without departing from the gist of the present disclosure. In the description in the following Examples, the term “part(s)” is by mass unless otherwise specified.

(Production Method for Anatase-Type Titanium Oxide Particles 1 to 7)

Anatase-type titanium oxide particles may be produced by a known sulfuric acid method. In the production of titanium oxide, a solution containing titanium sulfate and titanyl sulfate as titanium compounds is hydrolyzed through heating to produce a hydrous titanium dioxide slurry, and the titanium dioxide slurry is dewatered and fired. Thus, anatase-type titanium oxide particles each having an anatase degree of nearly 100% are obtained.

Anatase-type titanium oxide particles 1 to 7 were each produced by controlling the solution concentration of titanyl sulfate in the above-mentioned method.

(Production Method for Rutile-type Titanium Oxide Particles 1)

200 Parts by mass of ultra-fine titanium oxide (TTO-55(A): manufactured by Ishihara Sangyo Kaisha, Ltd.; average primary particle diameter (manufacturer's nominal value): 40 nm) was sealed in a tube made of Teflon (trademark) together with 10,000 parts by mass of an aqueous solution of potassium hydroxide having a concentration of 17 mol/L. The tube was hermetically sealed in a pressure-resistant glass vessel and kept at 110° C. for 20 hours to perform hydrothermal treatment. The reaction product was neutralized with an aqueous solution of hydrochloric acid having a concentration of 1 mol/L, and then washing with ion-exchanged water and centrifugation were repeated to provide a white precipitate. Further, the resultant white precipitate was dried and subsequently subjected to firing treatment at 650° C. for 30 minutes to provide rutile-type titanium oxide particles 1 each having a primary particle diameter of 32 nm.

The rutile-type titanium oxide particles 1 were subjected to X-ray diffraction spectrum (CuKα) measurement using RINT2000 (manufactured by Rigaku Corporation) to find diffraction peaks at 27.4°, 36.1°, 41.2°, and 54.3° attributed to rutile-type titanium oxide.

The number-average particle diameters of the anatase-type titanium oxide particles 1 to 7 and the rutile-type titanium oxide particles 1 produced in the foregoing are shown in Table 1.

TABLE 1

| | Number-average |
|---|---|
| Kind | particle diameter (nm) |
| Anatase-type titanium | 32 |
| oxide particles 1 | |
| Anatase-type titanium | 60 |
| oxide particles 2 | |
| Anatase-type titanium | 17 |
| oxide particles 3 | |
| Anatase-type titanium | 50 |
| oxide particles 4 | |
| Anatase-type titanium | 24 |
| oxide particles 5 | |
| Anatase-type titanium | 21 |
| oxide particles 6 | |
| Anatase-type titanium | 55 |
| oxide particles 7 | |
| Rutile-type titanium | 32 |
| oxide particles 1 | |

(Production of Metal Oxide Particles 1)

Niobium(V) hydroxide was dissolved in concentrated sulfuric acid, and the solution was mixed with an aqueous solution of titanium sulfate to prepare an acidic mixed liquid of a niobium salt and a titanium salt (hereinafter referred to as “titanium-niobium mixed liquid”).

The anatase-type titanium oxide particles 1 were dispersed as core particles in water to provide a suspension, and the suspension was heated to 70° C. while being stirred.

While the pH of the suspension was maintained at 2.5, the titanium-niobium mixed liquid having a content of 337 g/kg in terms of Ti and a content of 10.3 g/kg in terms of Nb, and an aqueous solution of sodium hydroxide were simultaneously added with respect to the weight of the anatase-type titanium oxide particles 1. After the completion of the dropwise addition, the suspension was filtered, washed, and dried at 110° C. for 8 hours. The dried product was fired together with an organic substance in a nitrogen atmosphere at 725° C. for 1 hour to provide metal oxide particles 1 each having a niobium atom localized in the vicinity of its surface.

The distribution of oxygen deficiency of the metal oxide particles was checked by the above-mentioned method. As a result, the relationship of the expression (α) was able to be recognized as shown in Table 2.

(Production of Metal Oxide Particles 2 to 14) In the production of the metal oxide particles 1, the kind of the core particles to be used in the suspension, the weights of niobium atoms and titanium atoms in the titanium-niobium mixed liquid at the time of covering, and the firing conditions of the dried product after formation of the covering layer were changed as shown in Table 2. Powders of metal oxide particles 2 to 14 shown in Table 2 were each obtained in the same manner as in the production of the metal oxide particles 1 except for the foregoing.

The distribution of oxygen deficiency of the metal oxide particles was checked by the above-mentioned method. As a result, the relationship of the expression (α) was able to be recognized in the metal oxide particles except the metal oxide particles 13 as shown in Table 2.

(Production of Metal Oxide Particles 15)

100 g of the anatase-type titanium oxide particles 4 and 1 g of hexametaphosphoric acid were added to 500 cm³ of water and dispersed with a bead mill. During the dispersion, a pH (pH=9 to 11) avoiding the isoelectric point of titanium oxide to be used was kept. A slurry after the dispersion was observed with a scanning electron microscope (SEM). As a result, it was able to be recognized that the materials were almost monodispersed. In addition, the slurry after the dispersion was measured for a medium diameter with a laser diffraction/scattering particle size distribution measuring apparatus (manufactured by Horiba, Ltd., model number: LA-950). As a result, the median diameter was 0.02 μm. The slurry was heated to 95° C. In the dispersion liquid, an aqueous solution of tin chloride was added in an amount of 25 g in terms of tin oxide, phosphoric acid was added to the aqueous solution of tin chloride so that the ratio of P was 0.8 mass % with respect to the weight of tin oxide, and crystals of a hydroxide of tin were deposited on the surface of titanium dioxide by a hydrolysis reaction. The powder subjected to the wet treatment was taken out, washed, and dried. Substantially the entire amount of tin chloride added in the above-mentioned wet treatment was hydrolyzed, and a stannic hydroxide compound (stannic hydroxide exhibiting a SnO₂ pattern in X-ray diffraction) was deposited on the powder surface. 20 g of the dry powder was placed in a quartz tubular furnace, increased in temperature at a temperature increase rate of 10° C./min, and fired in a nitrogen atmosphere for 2 hours while the temperature was controlled within a range of 700±50° C. Thus, metal oxide particles 15 were obtained.

The distribution of oxygen deficiency of the metal oxide particles was checked by the above-mentioned method. As a result, the relationship of the expression (α) was able to be recognized as shown in Table 2.

(Production of Metal Oxide Particles 16)

Niobium sulfate (water-soluble niobium compound) was added to a hydrous titanium dioxide slurry obtained by hydrolyzing an aqueous solution of titanyl sulfate. Niobium sulfate was added at a ratio of 1.8 mass % in terms of niobium ions with respect to the amount of titanium (in terms of titanium dioxide) in the slurry.

An aqueous solution of titanyl sulfate to which niobium sulfate was added at a ratio of 1.8 mass % in terms of niobium ions was hydrolyzed to provide a hydrous titanium dioxide slurry. Next, the hydrous titanium dioxide slurry containing niobium ions or the like was dewatered and fired in the air at a firing temperature of 1,000° C. Thus, metal oxide particles 16 that were anatase-type titanium oxide containing 1.8 mass % of niobium elements were obtained.

The distribution of oxygen deficiency of the metal oxide particles was checked by the above-mentioned method. As a result, the relationship of the expression (α) was not able to be recognized as shown in Table 3.

(Production of Metal Oxide Particles 17)

Metal oxide particles 17 were obtained by the same method as that of the metal oxide particles 1 except that the concentration of the aqueous solution of titanyl sulfate was adjusted.

The distribution of oxygen deficiency of the metal oxide particles was checked by the above-mentioned method. As a result, the relationship of the expression (α) was not able to be recognized as shown in Table 3.

(Production of Metal Oxide Particles 18 to 21) Niobium sulfate (water-soluble niobium compound) was added to a hydrous titanium dioxide slurry obtained by hydrolyzing an aqueous solution of titanyl sulfate. Niobium sulfate was added at a ratio of 0.2 mass % in terms of niobium ions with respect to the amount of titanium (in terms of titanium dioxide) in the slurry.

An aqueous solution of titanyl sulfate to which niobium sulfate was added at a ratio of 0.2 mass % in terms of niobium ions was hydrolyzed to provide a hydrous titanium dioxide slurry. Next, the hydrous titanium dioxide slurry containing niobium ions or the like was dewatered and fired in the air at a firing temperature of 850° C. Thus, metal oxide particles 18 that were anatase-type titanium oxide containing 0.2 mass % of niobium elements were obtained.

In addition, anatase-type titanium oxide particles 19 to 21 were each produced by controlling the concentration of the solution of titanyl sulfate in the above-mentioned method.

The distribution of oxygen deficiency of the metal oxide particles was checked by the above-mentioned method. As a result, the relationship of the expression (α) was not able to be recognized in any of the particles as shown in Table 3.

The number-average particle diameter, powder resistivity, and the ratio of niobium elements existing at 5% or less of a particle diameter from the outermost surface of each of the metal oxide particles 1 to 21 produced in the foregoing are also shown in Table 2 and Table 3.

TABLE 2

| | | | | | | Titanium-niobium |
|---|---|---|---|---|---|---|
| | | | | | | mixed liquid |
| | | | | | | Weight ratios of |
| | | | | | | niobium atom/titanium |
| | | Core particles | | | | atom with respect to |
| | Particle | | Particle | Firing | | titanium oxide in |
| | diameter | | diameter | Temperature | | suspension |
| | (nm) | Kind | (nm) | (° C.) | Atmosphere | (g/kg) |
| Metal oxide | 40 | Anatase-type | 32 | 725 | N₂ | 10.3/337 |
| particles 1 | | titanium oxide | | | | |
| | | particles 1 | | | | |
| Metal oxide | 68 | Anatase-type | 60 | 725 | N₂ | 10.3/337 |
| particles 2 | | titanium oxide | | | | |
| | | particles 2 | | | | |
| Metal oxide | 21 | Anatase-type | 17 | 725 | N₂ | 10.3/337 |
| particles 3 | | titanium oxide | | | | |
| | | particles 3 | | | | |
| Metal oxide | 60 | Anatase-type | 50 | 725 | N₂ | 10.3/337 |
| particles 4 | | titanium oxide | | | | |
| | | particles 4 | | | | |
| Metal oxide | 30 | Anatase-type | 24 | 725 | N₂ | 10.3/337 |
| particles 5 | | titanium oxide | | | | |
| | | particles 5 | | | | |
| Metal oxide | 25 | Anatase-type | 21 | 725 | N₂ | 10.3/337 |
| particles 6 | | titanium oxide | | | | |
| | | particles 6 | | | | |
| Metal oxide | 65 | Anatase-type | 55 | 800 | N₂ | 10.3/337 |
| particles 7 | | titanium oxide | | | | |
| | | particles 7 | | | | |
| Metal oxide | 40 | Anatase-type | 32 | 725 | N₂ | 2.1/337 |
| particles 8 | | titanium oxide | | | | |
| | | particles 1 | | | | |
| Metal oxide | 36 | Anatase-type | 32 | 725 | N₂ | 1.1/169 |
| particles 9 | | titanium oxide | | | | |
| | | particles 1 | | | | |
| Metal oxide | 34 | Anatase-type | 32 | 725 | N₂ | 0.7/112 |
| particles 10 | | titanium oxide | | | | |
| | | particles 1 | | | | |
| Metal oxide | 40 | Anatase-type | 32 | 725 | N₂ | 4.2/337 |
| particles 11 | | titanium oxide | | | | |
| | | particles 1 | | | | |
| Metal oxide | 40 | Anatase-type | 32 | 725 | N₂ | 20.6/337 |
| particles 12 | | titanium oxide | | | | |
| | | particles 1 | | | | |
| Metal oxide | 40 | Anatase-type | 32 | 725 | Air | 10.3/337 |
| particles 13 | | titanium oxide | | | | |
| | | particles 1 | | | | |
| Metal oxide | 40 | Rutile-type | 32 | 725 | N₂ | 10.3/337 |
| particles 14 | | titanium oxide | | | | |
| | | particles 1 | | | | |
| Metal oxide | 20 | Anatase-type | 17 | 500 | N₂ | — |
| particles 15 | | titanium oxide | | | | |
| | | particles 3 | | | | |

| | | | Oxygen | | |
|---|---|---|---|---|---|
| | | | deficiency | | |
| | | | rate (β) at | | |
| | | | 5% or less of | | |
| | | | primary particle | | |
| | | | diameter from | | |
| | | | surface/oxygen | | |
| | | | deficiency | | |
| | Covering layer | | rate (γ) at | Powder | Oxygen |
| | | Thickness | central portion | resistivity | deficiency |
| | Kind | (nm) | of particle | (Ω · cm) | rate |
| Metal oxide | Niobium-doped | 4 | 33 | 9.8E+06 | 1.8% |
| particles 1 | titanium oxide | | | | |
| Metal oxide | Niobium-doped | 5 | 32 | 7.2E+06 | 1.5% |
| particles 2 | titanium oxide | | | | |
| Metal oxide | Niobium-doped | 2 | 34 | 1.2E+07 | 2.0% |
| particles 3 | titanium oxide | | | | |
| Metal oxide | Niobium-doped | 5 | 34 | 8.2E+06 | 1.9% |
| particles 4 | titanium oxide | | | | |
| Metal oxide | Niobium-doped | 3 | 33 | 1.0E+07 | 1.7% |
| particles 5 | titanium oxide | | | | |
| Metal oxide | Niobium-doped | 2 | 33 | 1.0E+07 | 2.0% |
| particles 6 | titanium oxide | | | | |
| Metal oxide | Niobium-doped | 5 | 34 | 7.6E+06 | 1.9% |
| particles 7 | titanium oxide | | | | |
| Metal oxide | Niobium-doped | 4 | 34 | 6.5E+08 | 0.5% |
| particles 8 | titanium oxide | | | | |
| Metal oxide | Niobium-doped | 2 | 18 | 6.5E+08 | 0.3% |
| particles 9 | titanium oxide | | | | |
| Metal oxide | Niobium-doped | 1 | 11 | 6.5E+08 | 0.1% |
| particles 10 | titanium oxide | | | | |
| Metal oxide | Niobium-doped | 4 | 33 | 6.6E+07 | 0.9% |
| particles 11 | titanium oxide | | | | |
| Metal oxide | Niobium-doped | 4 | 34 | 1.2E+05 | 3.5% |
| particles 12 | titanium oxide | | | | |
| Metal oxide | Niobium-doped | 4 | 3 | 8.9E+08 | <0.1% |
| particles 13 | titanium oxide | | | | |
| Metal oxide | Niobium-doped | 4 | 33 | 3.3E+07 | 1.8% |
| particles 14 | titanium oxide | | | | |
| Metal oxide | Tin oxide | 1.5 | — | 1.9E+03 | 0.4% |
| particles 15 | | | | | |

TABLE 3

| | | Oxygen deficiency | | |
|---|---|---|---|---|
| | | rate (β) at | | |
| | | 5% or less of | | |
| | | primary particle | | |
| | Number- | diameter from | | |
| | average | surface/oxygen | | |
| | particle | deficiency rate | Powder | Oxygen |
| | diameter | (γ) at central | resistivity | deficiency |
| Kind | (nm) | portion of particle | (Ω · cm) | rate |
| Metal oxide | 40 | 1 | 2.8 × 10⁸ | <0.1% |
| particles 16 | | | | |
| Metal oxide | 40 | 1 | 3.0 × 10¹⁰ | <0.1% |
| particles 17 | | | | |
| Metal oxide | 17 | 1 | 1.2 × 10¹⁰ | <0.1% |
| particles 18 | | | | |
| Metal oxide | 20 | 1 | 9.9 × 10⁹ | <0.1% |
| particles 19 | | | | |
| Metal oxide | 70 | 1 | 8.8 × 10⁹ | <0.1% |
| particles 20 | | | | |
| Metal oxide | 100 | 1 | 4.8 × 10⁹ | <0.1% |
| particles 21 | | | | |
| SP-2 | 20 | 1 | 5.0 × 10² | <0.1% |
| S-2000 | 20 | 1 | 3.0 × 10¹ | <0.1% |
| M-1 | 350 | 2 | 5.5 × 10⁵ | 16% |
| ET-500W | 250 | 1 | 3.0 × 10 | <0.1% |
| AMT600 | 30 | 1 | 5.0 × 10¹⁰ | <0.1% |
| ST150 | 50 | 1 | 1.5 × 10¹⁰ | <0.1% |

<Production of Electrophotographic Photosensitive Members>

### (Production Example of Electrophotographic Photosensitive Member 1)

An aluminum cylinder having a diameter of 24 mm and a length of 257.5 mm (JIS-A3003, aluminum alloy) was used as a support (electroconductive support).

Next, the following materials were prepared.

| | |
|---|---|
| Titanium oxide (TiO₂) particles | 214 parts |
| (average primary particle diameter: 230 nm) | |
| coated with oxygen-deficient | |
| tin oxide (SnO₂): | |
| Phenol resin (product name: PLYOPHEN J-325, | 132 parts |
| manufactured by DIC Corporation, | |
| resin solid content: 60 mass %): | |
| 1-Methoxy-2-propanol: | 98 parts |

Those materials were placed in a sand mill using 450 parts of glass beads each having a diameter of 0.8 mm, and were subjected to dispersion treatment under the conditions of a rotation speed of 2,000 rpm, a dispersion treatment time of 4.5 hours, and a preset temperature of cooling water of 18° C. to provide a dispersion liquid. The glass beads were removed from the dispersion liquid with a mesh (aperture: 150 μm). To the resultant dispersion liquid, silicone resin particles (product name: TOSPEARL 120, manufactured by Momentive Performance Materials, average particle diameter: 2 μm) serving as a surface roughness-imparting material were added. The addition amount of the silicone resin particles was set to 10 mass % with respect to the total mass of the metal oxide particles and the binding material in the dispersion liquid after the removal of the glass beads. In addition, a silicone oil (product name: SH28PA, manufactured by Dow Toray Co., Ltd.) serving as a leveling agent was added to the dispersion liquid at 0.01 mass % with respect to the total mass of the metal oxide particles and the binding material in the dispersion liquid.

Next, a mixed solvent of methanol and 1-methoxy-2-propanol (mass ratio: 1:1) was added to the dispersion liquid so that the total mass of the metal oxide particles, the binding material, and the surface roughness-imparting material (i.e., the mass of the solid content) in the dispersion liquid became 67 mass % with respect to the mass of the dispersion liquid. After that, the mixture was stirred to prepare a coating liquid for an electroconductive layer. The coating liquid for an electroconductive layer was applied onto the support by dip coating, and the resultant was heated at 140° C. for 1 hour to form an electroconductive layer having a thickness of 30 μm.

Next, the following materials were prepared.

| | | |
|---|---|---|
| Electron-transporting substance (compound represented | 3.0 | parts |
| by the following formula (E-1)): | | |
| Blocked isocyanate (product name: DURANATE SBB-70P, | 6.5 | parts |
| manufactured by Asahi Kasei Chemicals Corporation): | | |
| Styrene-acrylic resin (product name: UC-3920, | 0.4 | part |
| manufactured by Toagosei Co., Ltd.): | | |
| Silica slurry (product name: IPA-ST-UP, | 1.8 | parts |
| manufactured by Nissan Chemical Industries, | | |
| Ltd., solid content concentration: 15 mass %, | | |
| viscosity: 9 mPa · s): | | |
| 1-Butanol: | 48 | parts |
| Acetone: | 24 | parts |

Those materials were mixed and dissolved to prepare a coating liquid for an undercoat layer. The coating liquid for an undercoat layer was applied onto the electroconductive layer by dip coating, and the resultant was heated at 170° C. for 30 minutes to form an undercoat layer having a thickness of 0.7 μm.

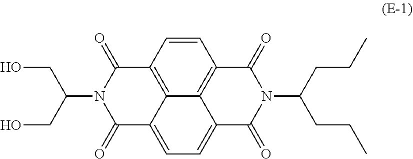 [SMILES: CCCC(CCC)N1C(=O)c2ccc3c4c(ccc(c24)C1=O)C(=O)N(C(CO)CO)C3=O]

Next, the following materials were prepared.
Hydroxygallium phthalocyanine of a crystal form having peaks at positions of 7.5° and 28.4° in a chart obtained by CuKα characteristic X-ray diffraction 10 parts
Polyvinyl butyral resin (product name: S-LEC BX-1, manufactured by Sekisui Chemical Co., Ltd.) 5 parts

Those materials were added to 200 parts of cyclohexanone, and the mixture was dispersed with a sand mill apparatus using glass beads each having a diameter of 0.9 mm for 6 hours.

The resultant was diluted by further adding 150 parts of cyclohexanone and 350 parts of ethyl acetate thereto to provide a coating liquid for a charge-generating layer. The resultant coating liquid was applied onto the undercoat layer by dip coating, followed by drying at 95° C. for 10 minutes to form a charge-generating layer having a thickness of 0.20 μm.

Next, the following materials were prepared.

| | | |
|---|---|---|
| Charge-transporting substance (hole-transportable | 6.0 | parts |
| substance) represented by the following | | |
| structural formula (C-1): | | |
| Charge-transporting substance (hole-transportable | 3.0 | parts |
| substance) represented by the following | | |
| structural formula (C-2): | | |
| Charge-transporting substance (hole-transportable | 1.0 | part |
| substance) represented by the following | | |
| structural formula (C-3): | | |
| Polycarbonate resin (product name: Iupilon Z400, | 10.0 | parts |
| manufactured by Mitsubishi Engineering-Plastics | | |
| Corporation): | | |
| Polycarbonate resin having a copolymerization unit | 0.02 | part |
| having a structure represented by the following | | |
| structural formula (C-4) and a structure represented | | |
| by the following structural | | |
| formula (C-5) (x/y = 0.95/0.05: viscosity- | | |
| average molecular weight = 20,000): | | |

Those materials were dissolved in a mixed solvent of 25 parts of o-xylene, 25 parts of methyl benzoate, and 25 parts of dimethoxymethane to prepare a coating liquid for a charge-transporting layer. The coating liquid for a charge-transporting layer was applied onto the charge-generating layer by dip coating to form a coat, and the coat was dried at 120° C. for 30 minutes to form a charge-transporting layer having a thickness of 22 μm.

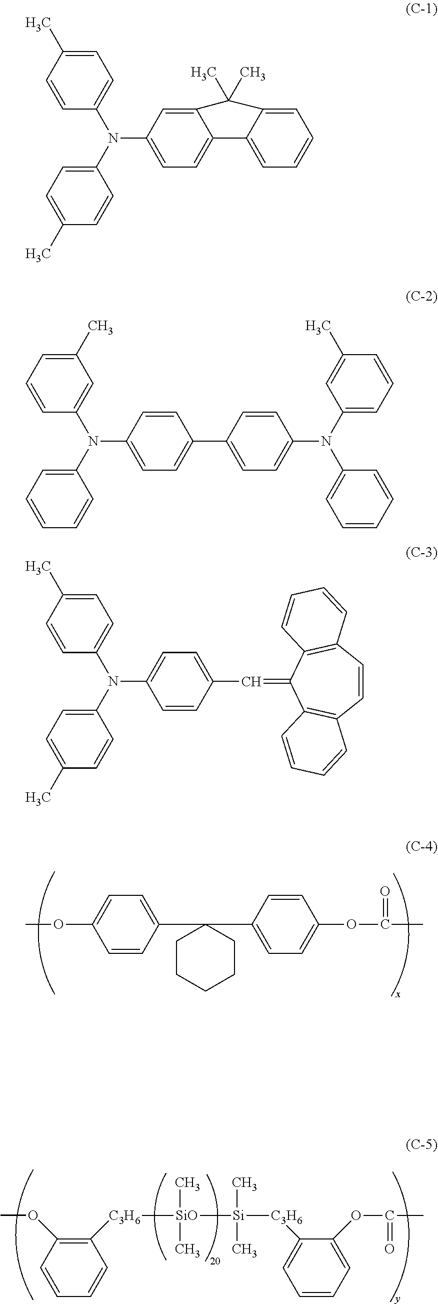

Next, the following materials were prepared.

| | |
|---|---|
| Metal oxide particles 1: | 100.0 parts |
| Surface treatment agent 1 (compound represented by | 6.0 parts |
| the following formula (S-1)) (product name: | |
| trimethoxypropylsilane, manufactured by Tokyo | |
| Chemical Industry Co., Ltd.): | |
| 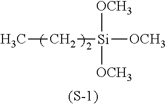 | |
| Toluene: | 200.0 parts |

Those materials were mixed and stirred with a stirring device for 4 hours, and then filtered and washed, followed further by heating treatment at 130° C. for 3 hours. Thus, surface-treated metal oxide particles 1 having an average primary particle diameter of 68 nm were obtained.

Next, the following materials were prepared.

| | |
|---|---|
| Surface-treated metal oxide particles 1: | 197.5 parts |
| Compound represented by the following | 79.0 parts |
| structural formula (O-1) and having a resistivity | |
| of 3.6 × 10¹² Ω · cm under an | |
| environment at a temperature of 32.5° C. and a humidity of | |
| 80% RH (HH), the compound serving as a binder resin: | |
| 1-Propanol (1-PA): | 100.0 parts |
| Cyclohexane (CH): | 100.0 parts |

The above-mentioned materials were mixed and stirred with a stirring device for 6 hours. Thus, a coating liquid 1 for a protection layer was prepared.

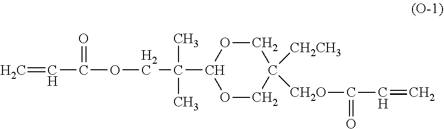

The coating liquid 1 for a protection layer was applied onto the charge-transporting layer by dip coating to form a coat, and the resultant coat was dried at 50° C. for 6 minutes. After that, under a nitrogen atmosphere, the coat was irradiated with an electron beam for 1.6 seconds under the conditions of an acceleration voltage of 70 kV and a beam current of 5.0 mA while the support (body to be irradiated) was rotated at a speed of 300 rpm. A dose at the position of the protection layer was 15 kGy. After that, under a nitrogen atmosphere, the temperature of the coat was increased to 117° C. An oxygen concentration during a period from the electron beam irradiation to the subsequent heating treatment was 10 ppm.

Next, in the air, the coat was naturally cooled until its temperature became 25° C., and then heating treatment was performed for 1 hour under such a condition that the temperature of the coat became 120° C., to thereby form a protection layer having a thickness of 0.5 m. Thus, an electrophotographic photosensitive member 1 including a protection layer containing the metal oxide particles 1 was produced.

In addition, the resistivity of the binder resin was measured as follows: a coating liquid 1 for a binder resin not containing surface-treated metal oxide particles in the coating liquid 1 for a protection layer was formed into a film by the same production method as in the coating liquid 1 for a protection layer, and the film was measured by the above-mentioned measurement method for a volume resistivity.

(Production Examples of Electrophotographic Photosensitive Members 2 to 20)

Electrophotographic photosensitive members 2 to 20 were each produced in the same manner as in the electrophotographic photosensitive member 1 except that the thickness of the protection layer was changed as shown in Table 4 by adjusting the kind and number of parts of the metal oxide, and the amount of the solvent.

(Production Example of Electrophotographic Photosensitive Member 21)

A coating liquid 21 for a protection layer was prepared in the same manner as in the production example of the electrophotographic photosensitive member 1 except that the kind and usage amount of each of the binder resin and the mixed solvent to be used for the preparation of the coating liquid for a protection layer were changed as described below.

33.7 Parts of a compound represented by the formula (CTM-1) and 3.7 parts of a compound represented by the formula (CTM-2), the compounds each serving as a binder resin, were dissolved in a mixed solution of 59.25 parts of o-xylene and 98.75 parts of methyl benzoate.

41.6 Parts of a polyester resin having a structural unit represented by the following formula (0-2) and a structural unit represented by the following formula (0-3) at a ratio of 5/5 and having a weight-average molecular weight (Mw) of 100,000 and a volume resistivity of 7.8×10¹⁴ Ω·cm at a temperature of 32.5° C. and a humidity of 80% RH (HH environment), a mixed solvent of 948 parts of chlorobenzene and 632 parts of dimethoxymethane, and 112.9 parts of the surface-treated metal oxide particles 1 were added to the above-mentioned mixed solution, and the mixture was stirred with a stirring device for 6 hours to provide a coating liquid 21 for a protection layer.

The resultant coating liquid 21 for a protection layer was applied onto the charge-transporting layer by dip coating to form a coat, and the coat was dried at 120° C. for 30 minutes to form a protection layer having a thickness of 0.5 m. An electrophotographic photosensitive member 21 was produced in the same manner as in the electrophotographic photosensitive member 1 except for the foregoing.

In addition, the resistivity of the binder resin was measured as follows: a coating liquid 21 for a binder resin not containing the surface-treated metal oxide particles 1 in the coating liquid 21 for a protection layer was formed into a film by the same production method as in the coating liquid 21 for a protection layer, and the film was measured by the above-mentioned measurement method for a volume resistivity.

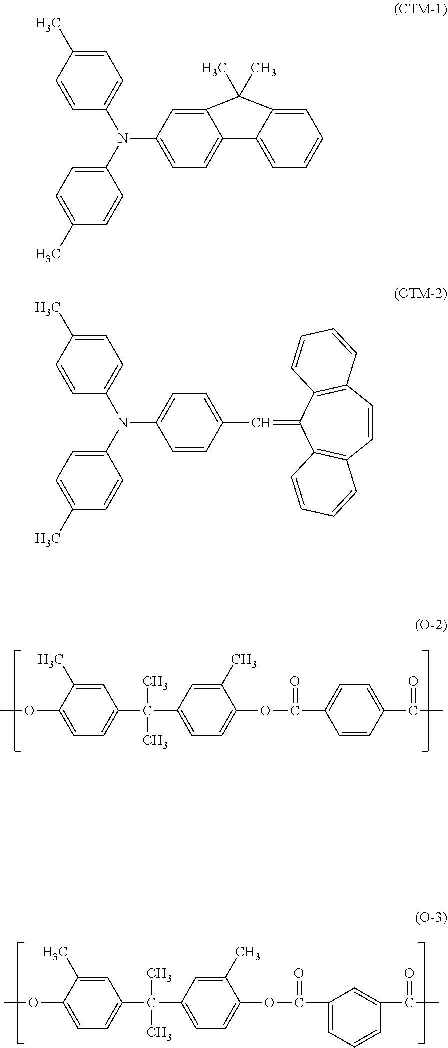

(Production Examples of Electrophotographic Photosensitive Members 22 to 68 and 70)

Electrophotographic photosensitive members 22 to 68 and 70 were each produced in the same manner as in the electrophotographic photosensitive member 21 except that the kind of the metal oxide particles, the presence or absence of the surface treatment of the metal oxide particles, and the number of parts thereof were changed as shown in Table 4 and Table 5.

(Production Example of Electrophotographic Photosensitive Member 69)

An electrophotographic photosensitive member 69 was produced in the same manner as in the electrophotographic photosensitive member 23 except that the metal oxide particles to be added to the protection layer and the number of parts of addition thereof were set to 196.1 parts of tin oxide particles without surface treatment (product name: SP-2, powder resistivity: 1× 10³ Ω·cm, average primary particle diameter: 20 nm, manufactured by Mitsubishi Materials Electronic Chemicals Co., Ltd.).

(Production Example of Electrophotographic Photosensitive Member 71)

An electrophotographic photosensitive member 71 was produced in the same manner as in the electrophotographic photosensitive member 23 except that a polycarbonate resin (1) having a structure represented by the formula (PC-I) and having a viscosity-average molecular weight of 40,000 and a volume resistivity of 2.5×10¹³ Ω·cm under an environment having a temperature of 32.5° C. and a humidity of 80% RH (HH) was used instead of the polyester resin.

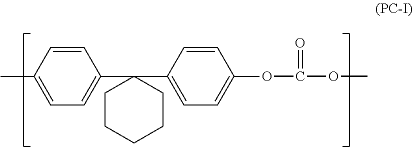

(Production Examples of Electrophotographic Photosensitive Members 72 and 73)

Electrophotographic photosensitive members 72 and 73 were each produced in the same manner as in the electrophotographic photosensitive member 71 except that the kind of the metal oxide, the number of parts thereof, and the thickness of the protection layer were shown in Table 5.

(Production Example of Electrophotographic Photosensitive Member 74)

A coating liquid 74 for a protection layer was prepared in the same manner as in the production example of the electrophotographic photosensitive member 1 except that the kind and usage amount of each of the binder resin and the mixed solvent to be used for the preparation of the coating liquid for a protection layer were changed as described below.

263.3 Parts of the surface-treated metal oxide particles 1, 59.25 parts of N-methoxymethylated nylon 6 (methoxymethylation rate: 28% to 33%), and 19.75 parts of a copolymerized nylon resin (product name: AMILAN CM8000, manufactured by Toray Industries, Inc.) were mixed with a mixed solvent of 1,185 parts of methanol and 790 parts of 1-butanol, and the mixture was stirred with a stirring device for 6 hours to prepare a coating liquid 74 for a protection layer.

The resultant coating liquid 74 for a protection layer was applied onto the charge-transporting layer by dip coating to form a coat, and the coat was dried at 100° C. for 30 minutes to form a protection layer having a thickness of 0.5 μm. An electrophotographic photosensitive member 74 was produced in the same manner as in the electrophotographic photosensitive member 1 except for the foregoing.

In addition, the resistivity of the binder resin was measured as follows: a coating liquid 74 for a binder resin not containing the surface-treated metal oxide particles 1 in the coating liquid 74 for a protection layer was formed into a film by the same production method as in the coating liquid 74 for a protection layer, and the film was measured by the above-mentioned measurement method for a volume resistivity. The volume resistivity of the binder resin under an environment having a temperature of 32.5° C. and a humidity of 80% RH (HH) was 6.1×10¹¹ Ω·cm.

(Production Method for Electrophotographic Photosensitive Member 75)

An electrophotographic photosensitive member 75 was produced in the same manner as in the electrophotographic photosensitive member 1 except that the following method was used as the method of forming a protection layer.

A mixture containing 18.2 parts of titanium oxide (M-1; primary particle diameter: 350 nm, manufactured by Ishihara Sangyo Kaisha, Ltd.), 7.8 parts of a polyvinyl butyral resin (XYHL; manufactured by Union Carbide Corporation), and 122.2 parts of cyclohexanone (manufactured by Kanto Chemical Co., Inc.) was placed in a ball mill pot and subjected to ball milling through use of SUS balls each having a diameter of 10 mm for 48 hours. After that, the milling liquid was taken out, and 10.2 parts of a 10% cyclohexanone solution of toluene-2,4-diisocyanate, 171.1 parts of cyclohexanone (manufactured by Kanto Chemical Co., Inc.), and 114.1 parts of methyl ethyl ketone (manufactured by Kanto Chemical Co., Inc.) were added to and mixed with the milling liquid, and the mixture was stirred to prepare a coating liquid for a protection layer. The coating liquid was applied onto the charge-transporting layer by spray coating, and then dried at 130° C. for 15 minutes to form a protection layer having a thickness of 2.5 μm.

(Production Method for Electrophotographic Photosensitive Member 76)

An electrophotographic photosensitive member 76 was produced in the same manner as in the electrophotographic photosensitive member 75 except that the materials for the coating liquid for a protection layer were changed to the following materials, and the thickness of the protection layer was set to 0.2 μm. The average particle diameter of the coating liquid for a protection layer was measured with a centrifugal automatic particle size distribution measuring apparatus CAPA-700 (manufactured by Horiba, Ltd.) to be 0.4 μm.

| | |
|---|---|
| Metal oxide particles 22: | 18 parts |
| Alcohol-soluble nylon (product name: AMILAN CM8000, | 8 parts |
| manufactured by Toray Industries, Inc.): | |
| Methanol: | 50 parts |
| Butanol: | 20 parts |

(Production Method for Electrophotographic Photosensitive Member 77)

A mixture containing 18.2 parts of titanium oxide (ET-500 W; primary particle diameter: 250 nm, manufactured by Ishihara Sangyo Kaisha, Ltd.), 3 parts of a naphthalenecarboxylic acid derivative represented by the formula (CTM-3) (manufactured by Ricoh Co., Ltd.) serving as a charge-transporting material, 7.8 parts of a polyvinyl butyral resin (XYHL; manufactured by Union Carbide Corporation), and 122.2 parts of cyclohexanone (manufactured by Kanto Chemical Co., Inc.) was placed in a ball mill pot and subjected to ball milling through use of SUS balls each having a diameter of 10 mm for 48 hours. After that, the milling liquid was taken out, and 10.2 g of a 10% cyclohexanone solution of toluene-2,4-diisocyanate, 171.1 g of cyclohexanone (manufactured by Kanto Chemical Co., Inc.), and 114.1 g of methyl ethyl ketone (manufactured by Kanto Chemical Co., Inc.) were added to and mixed with the milling liquid, and the mixture was stirred to prepare a coating liquid for a protection layer. An electrophotographic photosensitive member 77 was produced in the same manner as in the electrophotographic photosensitive member 1 except that the coating liquid for a protection layer was applied onto the charge-transporting layer by spray coating, and was dried at 130° C. for 15 minutes to form a protection layer having a thickness of 2 μm.

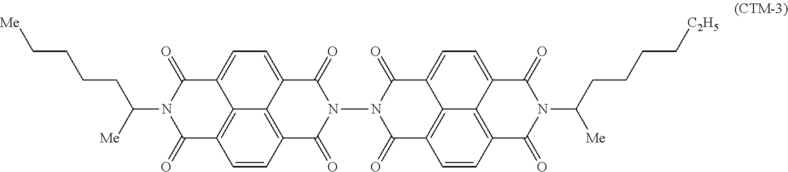 [SMILES: CCCCCCC(C)N1C(=O)c2ccc3c4c(ccc(c24)C1=O)C(=O)N(N1C(=O)c2ccc4c5c(ccc(c25)C1=O)C(=O)N(C(C)CCCCC)C4=O)C3=O]

(Production Method for Electrophotographic Photosensitive Member 78)

An electrophotographic photosensitive member 78 was produced in the same manner as in the electrophotographic photosensitive member 68 except that the metal oxide particles to be added to the protection layer and the number of parts of addition thereof were set to 196.1 parts of tin oxide particles without surface treatment (product name: S-2000, powder resistivity: 3×10 Ω·cm, average primary particle diameter: 20 nm, manufactured by Mitsubishi Materials Electronic Chemicals Co., Ltd.).

(Production Method for Electrophotographic Photosensitive Member 79)

An electrophotographic photosensitive member 79 was produced in the same manner as in the electrophotographic photosensitive member 1 except that the materials for the coating liquid for a protection layer and the method of forming a protection layer were set to materials and a method described below and the thickness of the protection layer was set to 3.0 μm.

20 Parts of the compound represented by the structural formula (0-1) was mixed with a mixed solvent of 130 parts of 2-propanol and 14 parts of tetrahydrofuran, and to the solution, 40 parts of anatase-type titanium oxide (AMT600, manufactured by Tayca Corporation (particle diameter: 30 nm)) and 2.00 parts of an organic salt represented by the following structural formula (A-1) were added, and the mixture was stirred.

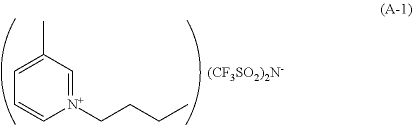

Those materials were placed in a vertical sand mill using 200 parts of glass beads having an average particle diameter of 1.0 mm, and were subjected to dispersion treatment for 2 hours under the conditions of a dispersion liquid temperature of 23±3° C. and a rotation speed of 1,500 rpm (peripheral speed: 5.5 m/s) to provide a dispersion liquid.

A dispersion liquid after the glass beads were removed from the dispersion liquid with a mesh was filtered under pressure through use of a PTFE paper filter (product name: PF060, manufactured by Advantec Toyo Kaisha, Ltd.) to prepare a coating liquid for a protection layer.

Next, the coating liquid for a protection layer was applied onto the charge-transporting layer by dip coating to form a coat, and the resultant coat was dried at 50° C. for 6 minutes. After that, the coat was irradiated with electron beams for 1.6 seconds while a support (object to be irradiated) was rotated at a speed of 300 rpm under the conditions of an acceleration voltage of 70 kV and a beam current of 2.0 mA under a nitrogen atmosphere. An oxygen concentration in the electron beam irradiation was 810 ppm. Next, in the air, the coat was naturally cooled until its temperature became 25° C., and then heating treatment was performed for 1 hour under such a condition that the temperature of the coat became 120° C., to thereby form a protection layer having a thickness of 3.0 μm. Thus, an electrophotographic photosensitive member 79 including the production layer and having a cylindrical shape (drum shape) was produced.

(Production Method for Electrophotographic Photosensitive Member 80) An electrophotographic photosensitive member 80 was produced in the same manner as in the electrophotographic photosensitive member 79 except that the kind of the metal oxide particles was set to rutile-type titanium oxide (SC150, manufactured by Tayca Corporation (particle diameter: 50 nm), powder resistivity: 1.3×10¹⁰ Ω·cm) and the kind of the organic salt was changed to an organic salt represented by the following structural formula (A-2) in the production method for the electrophotographic photosensitive member 79.

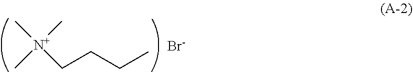

TABLE 4

| Electrophotographic | Metal oxide | | | | |
|---|---|---|---|---|---|
| photosensitive | | Number | Thickness/ | Surface | Binder |
| member No. | Kind | of parts | μm | treatment | resin |
| Electrophotographic | Metal oxide | 269.9 | 0.5 | Present | O-1 |
| photosensitive member 1 | particles 1 | | | | |
| Electrophotographic | Metal oxide | 269.9 | 0.05 | Present | O-1 |
| photosensitive member 2 | particles 1 | | | | |
| Electrophotographic | Metal oxide | 269.9 | 0.1 | Present | O-1 |
| photosensitive member 3 | particles 1 | | | | |
| Electrophotographic | Metal oxide | 269.9 | 1.0 | Present | O-1 |
| photosensitive member 4 | particles 1 | | | | |
| Electrophotographic | Metal oxide | 269.9 | 1.5 | Present | O-1 |
| photosensitive member 5 | particles 1 | | | | |
| Electrophotographic | Metal oxide | 269.9 | 2.0 | Present | O-1 |
| photosensitive member 6 | particles 1 | | | | |
| Electrophotographic | Metal oxide | 115.7 | 0.5 | Present | O-1 |
| photosensitive member 7 | particles 1 | | | | |
| Electrophotographic | Metal oxide | 202.4 | 0.5 | Present | O-1 |
| photosensitive member 8 | particles 1 | | | | |
| Electrophotographic | Metal oxide | 404.9 | 0.5 | Present | O-1 |
| photosensitive member 9 | particles 1 | | | | |
| Electrophotographic | Metal oxide | 809.8 | 0.5 | Present | O-1 |
| photosensitive member 10 | particles 1 | | | | |
| Electrophotographic | Metal oxide | 115.7 | 0.5 | Present | O-1 |
| photosensitive member 11 | particles 2 | | | | |
| Electrophotographic | Metal oxide | 202.4 | 0.5 | Present | O-1 |
| photosensitive member 12 | particles 2 | | | | |
| Electrophotographic | Metal oxide | 269.9 | 0.5 | Present | O-1 |
| photosensitive member 13 | particles 2 | | | | |
| Electrophotographic | Metal oxide | 404.9 | 0.5 | Present | O-1 |
| photosensitive member 14 | particles 2 | | | | |
| Electrophotographic | Metal oxide | 809.8 | 0.5 | Present | O-1 |
| photosensitive member 15 | particles 2 | | | | |
| Electrophotographic | Metal oxide | 115.7 | 0.5 | Present | O-1 |
| photosensitive member 16 | particles 3 | | | | |
| Electrophotographic | Metal oxide | 202.4 | 0.5 | Present | O-1 |
| photosensitive member 17 | particles 3 | | | | |
| Electrophotographic | Metal oxide | 269.9 | 0.5 | Present | O-1 |
| photosensitive member 18 | particles 3 | | | | |
| Electrophotographic | Metal oxide | 404.9 | 0.5 | Present | O-1 |
| photosensitive member 19 | particles 3 | | | | |
| Electrophotographic | Metal oxide | 809.8 | 0.5 | Present | O-1 |
| photosensitive member 20 | particles 3 | | | | |
| Electrophotographic | Metal oxide | 115.7 | 0.5 | Present | O-2/O-3 |
| photosensitive member 21 | particles 1 | | | | |
| Electrophotographic | Metal oxide | 179.9 | 0.5 | Present | O-2/O-3 |
| photosensitive member 22 | particles 1 | | | | |
| Electrophotographic | Metal oxide | 202.4 | 0.5 | Present | O-2/O-3 |
| photosensitive member 23 | particles 1 | | | | |
| Electrophotographic | Metal oxide | 269.9 | 0.5 | Present | O-2/O-3 |
| photosensitive member 24 | particles 1 | | | | |
| Electrophotographic | Metal oxide | 404.9 | 0.5 | Present | O-2/O-3 |
| photosensitive member 25 | particles 1 | | | | |
| Electrophotographic | Metal oxide | 501.3 | 0.5 | Present | O-2/O-3 |
| photosensitive member 26 | particles 1 | | | | |
| Electrophotographic | Metal oxide | 809.8 | 0.5 | Present | O-2/O-3 |
| photosensitive member 27 | particles 1 | | | | |
| Electrophotographic | Metal oxide | 115.7 | 0.5 | Present | O-2/O-3 |
| photosensitive member 28 | particles 2 | | | | |
| Electrophotographic | Metal oxide | 202.4 | 0.5 | Present | O-2/O-3 |
| photosensitive member 29 | particles 2 | | | | |
| Electrophotographic | Metal oxide | 269.9 | 0.5 | Present | O-2/O-3 |
| photosensitive member 30 | particles 2 | | | | |
| Electrophotographic | Metal oxide | 404.9 | 0.5 | Present | O-2/O-3 |
| photosensitive member 31 | particles 2 | | | | |
| Electrophotographic | Metal oxide | 809.8 | 0.5 | Present | O-2/O-3 |
| photosensitive member 32 | particles 2 | | | | |
| Electrophotographic | Metal oxide | 115.7 | 0.5 | Present | O-2/O-3 |
| photosensitive member 33 | particles 3 | | | | |
| Electrophotographic | Metal oxide | 202.4 | 0.5 | Present | O-2/O-3 |
| photosensitive member 34 | particles 3 | | | | |
| Electrophotographic | Metal oxide | 269.9 | 0.5 | Present | O-2/O-3 |
| photosensitive member 35 | particles 3 | | | | |
| Electrophotographic | Metal oxide | 404.9 | 0.5 | Present | O-2/O-3 |
| photosensitive member 36 | particles 3 | | | | |
| Electrophotographic | Metal oxide | 809.8 | 0.5 | Present | O-2/O-3 |
| photosensitive member 37 | particles 3 | | | | |
| Electrophotographic | Metal oxide | 179.9 | 0.5 | Present | O-2/O-3 |
| photosensitive member 38 | particles 4 | | | | |
| Electrophotographic | Metal oxide | 202.4 | 0.5 | Present | O-2/O-3 |
| photosensitive member 39 | particles 4 | | | | |
| Electrophotographic | Metal oxide | 269.9 | 0.5 | Present | O-2/O-3 |
| photosensitive member 40 | particles 4 | | | | |

TABLE 5

| Electrophotographic | Metal oxide | | | | |
|---|---|---|---|---|---|
| photosensitive | | Number | Thickness/ | Surface | Binder |
| member No. | Kind | of parts | μm | treatment | resin |
| Electrophotographic | Metal oxide | 404.9 | 0.5 | Present | O-2/O-3 |
| photosensitive member 41 | particles 4 | | | | |
| Electrophotographic | Metal oxide | 459.6 | 0.5 | Present | O-2/O-3 |
| photosensitive member 42 | particles 4 | | | | |
| Electrophotographic | Metal oxide | 179.9 | 0.5 | Present | O-2/O-3 |
| photosensitive member 43 | particles 5 | | | | |
| Electrophotographic | Metal oxide | 202.4 | 0.5 | Present | O-2/O-3 |
| photosensitive member 44 | particles 5 | | | | |
| Electrophotographic | Metal oxide | 269.9 | 0.5 | Present | O-2/O-3 |
| photosensitive member 45 | particles 5 | | | | |
| Electrophotographic | Metal oxide | 404.9 | 0.5 | Present | O-2/O-3 |
| photosensitive member 46 | particles 5 | | | | |
| Electrophotographic | Metal oxide | 459.6 | 0.5 | Present | O-2/O-3 |
| photosensitive member 47 | particles 5 | | | | |
| Electrophotographic | Metal oxide | 202.4 | 0.5 | Present | O-2/O-3 |
| photosensitive member 48 | particles 6 | | | | |
| Electrophotographic | Metal oxide | 404.9 | 0.5 | Present | O-2/O-3 |
| photosensitive member 49 | particles 6 | | | | |
| Electrophotographic | Metal oxide | 202.4 | 0.5 | Present | O-2/O-3 |
| photosensitive member 50 | particles 7 | | | | |
| Electrophotographic | Metal oxide | 404.9 | 0.5 | Present | O-2/O-3 |
| photosensitive member 51 | particles 7 | | | | |
| Electrophotographic | Metal oxide | 269.9 | 0.5 | Present | O-2/O-3 |
| photosensitive member 52 | particles 8 | | | | |
| Electrophotographic | Metal oxide | 269.9 | 0.5 | Present | O-2/O-3 |
| photosensitive member 53 | particles 9 | | | | |
| Electrophotographic | Metal oxide | 269.9 | 0.5 | Present | O-2/O-3 |
| photosensitive member 54 | particles 10 | | | | |
| Electrophotographic | Metal oxide | 269.9 | 0.5 | Present | O-2/O-3 |
| photosensitive member 55 | particles 11 | | | | |
| Electrophotographic | Metal oxide | 269.9 | 0.5 | Present | O-2/O-3 |
| photosensitive member 56 | particles 12 | | | | |
| Electrophotographic | Metal oxide | 269.9 | 0.5 | Present | O-2/O-3 |
| photosensitive member 57 | particles 13 | | | | |
| Electrophotographic | Metal oxide | 263.3 | 0.5 | Present | O-2/O-3 |
| photosensitive member 58 | particles 16 | | | | |
| Electrophotographic | Metal oxide | 112.9 | 0.5 | Present | O-2/O-3 |
| photosensitive member 59 | particles 17 | | | | |
| Electrophotographic | Metal oxide | 263.3 | 0.5 | Present | O-2/O-3 |
| photosensitive member 60 | particles 18 | | | | |
| Electrophotographic | Metal oxide | 112.9 | 0.5 | Present | O-2/O-3 |
| photosensitive member 61 | particles 19 | | | | |
| Electrophotographic | Metal oxide | 263.3 | 0.5 | Present | O-2/O-3 |
| photosensitive member 62 | particles 19 | | | | |
| Electrophotographic | Metal oxide | 263.3 | 0.5 | Present | O-2/O-3 |
| photosensitive member 63 | particles 20 | | | | |
| Electrophotographic | Metal oxide | 263.3 | 0.5 | Present | O-2/O-3 |
| photosensitive member 64 | particles 21 | | | | |
| Electrophotographic | Metal oxide | 87.8 | 0.5 | Present | O-2/O-3 |
| photosensitive member 65 | particles 21 | | | | |
| Electrophotographic | Metal oxide | 112.9 | 0.5 | Present | O-2/O-3 |
| photosensitive member 66 | particles 21 | | | | |
| Electrophotographic | Metal oxide | 790.0 | 0.5 | Present | O-2/O-3 |
| photosensitive member 67 | particles 21 | | | | |
| Electrophotographic | Metal oxide | 289.7 | 0.5 | Present | O-2/O-3 |
| photosensitive member 68 | particles 14 | | | | |
| Electrophotographic | SP-2 | 196.1 | 0.5 | Absent | O-2/O-3 |
| photosensitive member 69 | | | | | |
| Electrophotographic | Metal oxide | 141.1 | 0.5 | Absent | O-2/O-3 |
| photosensitive member 70 | particles 15 | | | | |
| Electrophotographic | Metal oxide | 202.4 | 0.5 | Present | PC-1 |
| photosensitive member 71 | particles 1 | | | | |
| Electrophotographic | Metal oxide | 269.9 | 0.5 | Present | PC-1 |
| photosensitive member 72 | particles 1 | | | | |
| Electrophotographic | Metal oxide | 404.9 | 0.5 | Present | PC-1 |
| photosensitive member 73 | particles 1 | | | | |
| Electrophotographic | Metal oxide | 269.9 | 0.5 | Present | Nylon |
| photosensitive member 74 | particles 1 | | | | |
| Electrophotographic | M-1 | 18.2 | 2.5 | Absent | Butyral |
| photosensitive member 75 | | | | | |
| Electrophotographic | Metal oxide | 18.0 | 0.2 | Absent | Nylon |
| photosensitive member 76 | particles 21 | | | | |
| Electrophotographic | ET-500W | 18.2 | 2.0 | Absent | Butyral |
| photosensitive member 77 | | | | | |
| Electrophotographic | S-2000 | 196.1 | 0.5 | Absent | PC-1 |
| photosensitive member 78 | | | | | |
| Electrophotographic | AMT600 | 40.0 | 3.0 | Absent | O-1 |
| photosensitive member 79 | | | | | |
| Electrophotographic | SC150 | 40.0 | 3.0 | Absent | O-1 |
| photosensitive member 80 | | | | | |

### Examples 1 to 73 and Comparative Examples 1 to 8

Measurement of the physical properties of the electrophotographic photosensitive members produced in the foregoing, evaluation of the fineness of output images, and evaluation of an injecting property were performed.

The cases of using the electrophotographic photosensitive members 1 to 59, 61 to 63, 68 to 74, and 78 to 80 correspond to Examples 1 to 73, and the cases of using the electrophotographic photosensitive members 60, 64 to 67, and 75 to 77 correspond to Comparative Examples 1 to 8.

<Measurement of Physical Properties of Electrophotographic Photosensitive Member>

A method of measuring each of the physical properties of the electrophotographic photosensitive member according to the present disclosure is described below.

<Calculation of Primary Particle Diameter of Metal Oxide Particles>

First, the electrophotographic photosensitive member was entirely immersed in methyl ethyl ketone (MEK) in a graduated cylinder and irradiated with an ultrasonic wave to peel off resin layers, and then the substrate of the electrophotographic photosensitive member was taken out. Next, insoluble matter that did not dissolve in MEK (the photosensitive layer and the protection layer containing the metal oxide particles) was filtered, and was brought to dryness with a vacuum dryer. Further, the resultant solid was suspended in a mixed solvent of tetrahydrofuran (THF) and methylal at a volume ratio of 1:1, insoluble matter was filtered, and then the filtration residue was recovered and brought to dryness with a vacuum dryer. Through this operation, the metal oxide particles and the resin of the protection layer were obtained. Further, the filtration residue was heated in an electric furnace to 500° C. so as to leave only the metal oxide particles as solids, and the metal oxide particles were collected. In order to secure an amount of the metal oxide particles required for measurement, a plurality of electrophotographic photosensitive members were similarly treated.

Part of the collected metal oxide particles were dispersed in isopropanol (IPA), and the dispersion liquid was dropped onto a grid mesh with a support membrane (Cu150J, manufactured by JEOL Ltd.), followed by the observation of the metal oxide particles in the STEM mode of a scanning transmission electron microscope (JEM2800, manufactured by JEOL Ltd.). The observation was performed at a magnification of from 500,000 to 1,200,000 so as to facilitate the calculation of the particle diameter of the metal oxide particles, and STEM images of 100 metal oxide particles were taken. At this time, the following settings were adopted: an acceleration voltage of 200 kV, a probe size of 1 nm, and an image size of 1,024×1,024 pixels.

Through use of the resultant STEM images, a primary particle diameter was measured with image processing software “Image-Pro Plus (manufactured by Media Cybernetics, Inc.)”. First, a scale bar displayed in the lower portion of the STEM image is selected through use of the straight line tool (Straight Line) of the tool bar. When the “Set Scale” of the “Analyze” menu is selected under the state, a new window is opened, and the pixel distance of a selected straight line is input in the “Distance in Pixels” column. The value (e.g., 100) of the scale bar is input in the “Known Distance” column of the window, and the unit (e.g., nm) of the scale bar is input in the “Unit of Measurement” column, followed by the clicking of OK. Thus, scale setting is completed. Next, a straight line was drawn so as to coincide with the maximum diameter of a metal oxide particle through use of the straight line tool, and the particle diameter was calculated. The same operation was performed for 100 metal oxide particles, and the number average of the resultant values (maximum diameters) was adopted as the primary particle diameter of the metal oxide particles.

<Calculation of Niobium Atom/Titanium Atom Concentration Ratio>

One 5 mm square sample piece was cut out of the photosensitive member, and was cut to a thickness of 200 nm with an ultrasonic ultramicrotome (Leica, UC7) at a cutting speed of 0.6 mm/s to produce a slice sample. The slice sample was observed at a magnification of from 500,000 to 1,200,000 in the STEM mode of a scanning transmission electron microscope (JEM2800, manufactured by JEOL Ltd.) having connected thereto an EDS analyzer (energy-dispersive X-ray spectrometer).

Of the metal oxide particles observed, metal oxide particles each having a maximum diameter that was about 0.9 or more times as large as the primary particle diameter calculated in the foregoing were selected through visual observation. Subsequently, spectra of the constituent elements of the selected metal oxide particles were collected through use of the EDS analyzer to produce EDS mapping images. The collection and analysis of the spectra were performed through use of NSS (Thermo Fisher Scientific). Collection conditions were set to an acceleration voltage of 200 kV, a probe size of 1.0 nm or 1.5 nm appropriately selected so as to achieve a dead time of 15 or more and 30 or less, a mapping resolution of 256×256, and a Frame number of 300. The EDS mapping images were obtained for 100 metal oxide particles.

The thus obtained EDS mapping images are each analyzed to calculate a ratio between a niobium atom concentration (atomic %) and a titanium atom concentration (atomic %) at each of the central portion of a particle and an inside portion at 5% of the maximum diameter of a measurement particle from the surface of the particle. Specifically, first, the “Line Extraction” button of NSS is pressed to draw a straight line so as to coincide with the maximum diameter of the particle, and information is obtained on an atom concentration (atomic %) on the straight line extending from one surface, passing through the inside of the particle, and reaching the other surface. When the maximum diameter of the particle obtained at this time is less than 0.9 times as large as the primary particle diameter of the particle calculated in the foregoing, the particle was excluded from the subsequent analysis. That is, only particles each having a maximum diameter that is 0.9 or more times as large as the primary particle diameter were subjected to the analysis described below. Next, on the surfaces on both sides of the particle, the niobium atom concentration (atomic %) at the inside portion at 5% of the maximum diameter of the measurement particle from the surface of the particle is read, and an arithmetic mean value of the obtained two values is calculated to obtain the “niobium atom concentration (atomic %) at the inside portion at 5% of the maximum diameter of the measurement particle from the surface of the particle”. Similarly, the “titanium atom concentration (atomic %) at the inside portion at 5% of the maximum diameter of the measurement particle from the surface of the particle” is obtained. Then, through use of those values, the “concentration ratio between the niobium atom and the titanium atom at the inside portion at 5% of the maximum diameter of the measurement particle from the surface of the particle” is obtained from the following equation.

Concentration ratio between niobium atom and titanium atom at inside portion at 5% of maximum diameter of measurement particle from surface of particle=(niobium atom concentration (atomic %) at inside portion at 5% of maximum diameter of measurement particle from surface of particle)/(titanium atom concentration (atomic %) at inside portion at 5% of maximum diameter of measurement particle from surface of particle)

In addition, a niobium atom concentration (atomic %) and a titanium atom concentration (atomic %) at a position located on the above-mentioned straight line and coinciding with the middle point of the maximum diameter are read. Through use of those values, the “concentration ratio between the niobium atom and the titanium atom at the central portion of the particle” is obtained from the following equation.

Concentration ratio between niobium atom and titanium atom at central portion of particle=(niobium atom concentration (atomic %) at central portion of particle)/(titanium atom concentration (atomic %) at central portion of particle)

The “concentration ratio calculated as niobium atom concentration/titanium atom concentration at the inside portion at 5% of the maximum diameter of the measurement particle from the surface of the particle relative to the concentration ratio calculated as niobium atom concentration/titanium atom concentration at the central portion of the particle” is calculated by the following equation.

(Concentration ratio calculated as niobium atom concentration/titanium atom concentration at inside portion at 5% of maximum diameter of measurement particle from surface of particle relative to concentration ratio calculated as niobium atom concentration/titanium atom concentration at central portion of particle)=(Concentration ratio between niobium atom concentration and titanium atom concentration at inside portion at 5% of maximum diameter of measurement particle from surface of particle)/(concentration ratio between niobium atom and titanium atom at central portion of particle)

<Calculation of Content of Metal Oxide Particles>

Next, four 5 mm square sample pieces were cut out of the electrophotographic photosensitive member, and the protection layer was reconstructed into a three-dimensional object of 2 μm×2 μm×2 μm with Slice & View of FIB-SEM. Based on a difference in contrast of Slice & View of FIB-SEM, the content of the metal oxide particles in the total volume of the protection layer was calculated. The conditions of Slice & View were set as described below.
Processing of sample for analysis: FIB method
Processing and observation device: NVision 40 manufactured by SII/Zeiss
Slice interval: 5 nm
Observation conditions:
Acceleration voltage: 1.0 kV
Sample tilt: 540
WD: 5 mm
Detector: BSE detector
Aperture: 60 m, high current
ABC: ON
Image resolution: 1.25 nm/pixel

An analysis region was set to 2 μm long by 2 μm wide, and information for each cross-section was integrated to determine a volume V per 2 μm long by 2 μm wide by 2 m thick (8 μm³). In addition, a measurement environment had a temperature of 23° C. and a pressure of 1×10⁻⁴ Pa. Strata 400S manufactured by FEI (sample tilt: 52°) may also be used as the processing and observation device. In addition, the information for each cross-section was obtained through image analysis of the area of the metal oxide particle. The image analysis was performed through use of image processing software: Image-Pro Plus manufactured by Media Cybernetics, Inc.

Based on the resultant information, in each of the four sample pieces, the volume V of the metal oxide particles in a volume of 2 μm×2 μm×2 μm (unit volume: 8 μm³) was determined, and (V μm³/8 μm³×100) was calculated. The average of the values of (V μm³/8 μm³×100) in the four sample pieces was defined as the content ratio [vol %] of the metal oxide particles in the protection layer with respect to the total volume of the protection layer.

Further, all of the four sample pieces were processed to a boundary between the protection layer and the underlying layer to measure the thickness “t” (μm) of the protection layer, and the value of the thickness of the protection layer was used for the calculation of a volume resistivity p, in <Measurement Method for Volume Resistivity of Protection Layer of Photosensitive Member> described below.

The obtained results are shown in Table 6 and Table 7.

<Quantification of Niobium Atom contained in Metal Oxide Particles>

Quantification of a niobium atom contained in the metal oxide particles is performed as described below.

The metal oxide particles collected from the electrophotographic photosensitive member in <Calculation of Primary Particle Diameter of Metal Oxide Particles> described above are pelletized by press molding described below to produce a sample. Measurement is performed with a fluorescence X-ray analyzer (XRF) through use of the produced sample, and the niobium atom content of the entirety of the metal oxide particles is quantified by an FP method.

Specifically, the content is quantified as niobium pentoxide is performed and converted into the niobium atom content.

(i) Example of Apparatus Used

Fluorescence X-ray analyzer 3080 (manufactured by Rigaku Corporation)

(ii) Preparation of Sample

For sample preparation, a sample press molding machine (manufactured by MAEKAWA Testing Machine MFG. Co., LTD.) is used. 0.5 g of the metal oxide particles are loaded into an aluminum ring (model number: 3481E1), and the aluminum ring is set to a load of 5.0 tons. The metal oxide particles are pressed for 1 minute to be pelletized.

(iii) Measurement Conditions
Measurement diameter: 10φ
Measurement potential and voltage: 50 kV, from 50 mA to 70 mA
2θ angle: 25.12°
Crystal plate: LiF
Measurement time: 60 seconds

<Measurement Method for Volume Resistivity of Protection Layer>

For measurement of a volume resistivity of the present disclosure, a picoampere (pA) meter was used.

First, such comb-shaped gold electrodes as illustrated in FIG. 5 having an electrode-to-electrode distance (D) of 180 μm and a length (L) of 59 mm are produced on a PET film by gold vapor deposition. A protection layer having a thickness (T1) of 2 μm is formed on the produced comb-shaped gold electrodes. Next, under each of an environment having a temperature of 23° C. and a humidity of 50% RH and an environment having a temperature of 32.5° C. and a humidity of 80% RH, a DC current (I) at the time of the application of a DC voltage (V) of 100 V between the comb-shaped gold electrodes was measured, and a volume resistivity p, (Ω·cm) was obtained by the following expression (6).

Volume resistivity ρᵥ(Ω·cm)=V(V)×T1 (cm)×L (cm)/{I(A)×D (cm)}(6)

When the composition, including the metal oxide particles, the binder resin, and the like, of the protection layer is difficult to identify, the surface resistivity of the electrophotographic photosensitive member is measured and converted into the volume resistivity. When the volume resistivity of not the protection layer alone, but the protection layer in a state of being applied to the surface of the electrophotographic photosensitive member is measured, it is desired that the surface resistivity of the protection layer be measured, and the resultant value be converted into the volume resistivity.

In the present disclosure, such comb-shaped gold electrodes as illustrated in FIG. 5 having an electrode-to-electrode distance (D) of 180 μm and a length (L) of 59 mm are produced on the surface of the protection layer of the electrophotographic photosensitive member by gold vapor deposition. Next, under an environment having a temperature of 23° C. and a humidity of 50% RH, a DC current (I) at the time of the application of a DC voltage (V) of 1,000 V between the comb-shaped gold electrodes was measured, and the surface resistivity ρs of the protection layer was calculated from DC voltage (V)/DC current (I).

Further, the volume resistivity p, (Ω·cm) was calculated by the following expression (7) through use of the thickness “t” (cm) of the protection layer measured in <Analysis of Cross-section of Protection Layer of Electrophotographic Photosensitive Member> described above.

ρᵥ=ρₛ×t (7)

(ρᵥ: volume resistivity, ρₛ: surface resistivity, t: thickness of protection layer)

This measurement involves measuring a minute current amount, and hence is preferably performed through use of, as a resistance-measuring apparatus, an instrument capable of measuring a minute current. For example, there is given a picoammeter 4140B manufactured by Hewlett-Packard Company. The comb-shaped gold electrodes to be used and the voltage to be applied are desirably selected in accordance with the material and resistance value of a charge injection layer so that an appropriate SN ratio may be obtained.

[Evaluation]

### (Evaluation of Fineness of Output Image)

A reconstructed machine of a laser beam printer (Color LaserJet Enterprise M552, manufactured by Hewlett-Packard Company) was used as an electrophotographic apparatus for evaluation. As the reconstruction points, the laser beam printer was reconstructed so as to be operated with variable charging conditions and laser exposure amounts. Each of the electrophotographic photosensitive members produced in the foregoing was mounted on a process cartridge for a black color and mounted on a station of the process cartridge for a black color so that the laser beam printer was operated even when process cartridges for other colors (cyan, magenta, and yellow) were not mounted on the main body of the laser beam printer. For output of an image, only the process cartridge for a black color was mounted on the main body of the laser beam printer, and a monochromatic image with only a black toner was output. In addition, a laser intensity was adjusted so that a dark portion potential Vd became −600 V and a light portion potential Vl became −250 V, and a developing bias Vdc applied to the charging member was adjusted to −450 V.

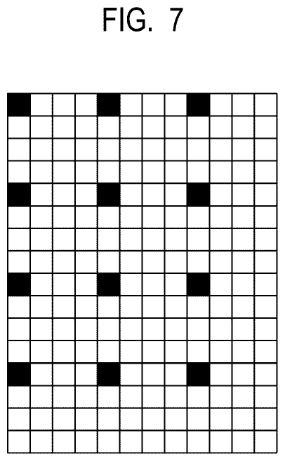

The fineness of the output image was evaluated based on the density of the output image when an image pattern (isolated dot pattern) exposed at 3-dot intervals for each exposure dot as illustrated in FIG. 7 was output under an environment having a temperature of 32.5° C. and a relative humidity of 80%. When a latent image of the isolated dot pattern is clearly formed on the electrophotographic photosensitive member, the image of the isolated dot pattern is clearly output on paper, resulting in an output product with high image density. In addition, when the latent image of the isolated dot pattern is not clearly formed on the electrophotographic photosensitive member, the image of the isolated dot pattern is not clearly output on the paper, resulting in an output product with low image density. Thus, the fineness of the output image can be evaluated based on the degree of the resultant density of the output image.

The density of the output image was calculated from the difference between the whiteness of a portion in which the exposed image pattern was formed and the whiteness of a portion in which the exposed image pattern was not formed (blank portion) in the output image. The density of the output image was measured with an amber filter through use of a white photometer TC-6DS/A manufactured by Tokyo Denshoku Co., Ltd. In the present disclosure, when the density of the resultant output image was 8.0% or more, it was determined that the fineness of the output image was high. The results are shown in Table 6 and Table 7.

(Evaluation of Injecting Property)

A reconstructed machine of an electrophotographic apparatus (laser beam printer) (product name: HP LaserJet Enterprise Color M553dn, manufactured by Hewlett-Packard Company) was used for evaluation of an injecting property. The electrophotographic apparatus used for evaluation was reconstructed so that a voltage applied to the charging roller was allowed to be regulated and measured.

In addition, a process cartridge for a cyan color of the electrophotographic apparatus was reconstructed to mount a potential probe (model 6000B-8: manufactured by Trek Japan) at the development position thereof. Next, with regard to a surface potential at the central portion of the electrophotographic photosensitive member, a surface potentiometer (model 344: manufactured by Trek Japan) was used and adapted to be capable of measuring the surface potential.

Under an environment having a temperature of 23.0° C. and a humidity of 55% RH, the electrophotographic photosensitive member of each of Examples and Comparative Examples was mounted, and a DC current of −500 V was applied to the charging roller, and the electrophotographic photosensitive member was charged while being rotated at 60 rpm. A potential A of the surface of the electrophotographic photosensitive member at this time was measured to determine an injecting property of A/−500. The results are shown in Table 6 and Table 7.

TABLE 6

| | | | | | Content ratio | |
|---|---|---|---|---|---|---|
| | | Resistance of | Resistance of | | of metal | |
| | | protection | protection | Resistance | oxide in | Thickness of |
| | Electrophotographic | layer | layer | of resin | protection | protection |
| Example | photosensitive | under HH | under NN | under HH | layer | layer |
| No. | member No. | environment | environment | environment | (vol %) | (μm) |
| Example 1 | 1 | 4.3 × 10¹¹ | 2.6 × 10¹² | 3.6 × 10¹² | 50% | 0.5 |
| Example 2 | 2 | 4.3 × 10¹¹ | 2.6 × 10¹² | 3.6 × 10¹² | 50% | 0.05 |
| Example 3 | 3 | 4.3 × 10¹¹ | 2.6 × 10¹² | 3.6 × 10¹² | 50% | 0.1 |
| Example 4 | 4 | 4.3 × 10¹¹ | 2.6 × 10¹² | 3.6 × 10¹² | 50% | 1.0 |
| Example 5 | 5 | 4.3 × 10¹¹ | 2.6 × 10¹² | 3.6 × 10¹² | 50% | 1.5 |
| Example 6 | 6 | 4.3 × 10¹¹ | 2.6 × 10¹² | 3.6 × 10¹² | 50% | 2.0 |
| Example 7 | 7 | 9.1 × 10¹¹ | 6.6 × 10¹² | 3.6 × 10¹² | 30% | 0.5 |
| Example 8 | 8 | 6.2 × 10¹¹ | 4.3 × 10¹² | 3.6 × 10¹² | 43% | 0.5 |
| Example 9 | 9 | 3.5 × 10¹¹ | 2.1 × 10¹² | 3.6 × 10¹² | 60% | 0.5 |
| Example 10 | 10 | 2.7 × 10¹¹ | 1.6 × 10¹² | 3.6 × 10¹² | 75% | 0.5 |
| Example 11 | 11 | 7.0 × 10¹¹ | 5.2 × 10¹² | 3.6 × 10¹² | 30% | 0.5 |
| Example 12 | 12 | 4.5 × 10¹¹ | 3.2 × 10¹² | 3.6 × 10¹² | 43% | 0.5 |
| Example 13 | 13 | 3.0 × 10¹¹ | 2.1 × 10¹² | 3.6 × 10¹² | 50% | 0.5 |
| Example 14 | 14 | 2.3 × 10¹¹ | 1.6 × 10¹² | 3.6 × 10¹² | 60% | 0.5 |
| Example 15 | 15 | 1.9 × 10¹¹ | 1.3 × 10¹² | 3.6 × 10¹² | 75% | 0.5 |
| Example 16 | 16 | 1.2 × 10¹² | 9.7 × 10¹² | 3.6 × 10¹² | 30% | 0.5 |
| Example 17 | 17 | 7.6 × 10¹¹ | 6.1 × 10¹² | 3.6 × 10¹² | 43% | 0.5 |
| Example 18 | 18 | 5.3 × 10¹¹ | 4.1 × 10¹² | 3.6 × 10¹² | 50% | 0.5 |
| Example 19 | 19 | 4.2 × 10¹¹ | 3.2 × 10¹² | 3.6 × 10¹² | 60% | 0.5 |
| Example 20 | 20 | 3.3 × 10¹¹ | 2.3 × 10¹² | 3.6 × 10¹² | 75% | 0.5 |
| Example 21 | 21 | 4.5 × 10¹² | 3.2 × 10¹³ | 7.8 × 10¹⁴ | 30% | 0.5 |
| Example 22 | 22 | 2.5 × 10¹² | 1.7 × 10¹³ | 7.8 × 10¹⁴ | 40% | 0.5 |
| Example 23 | 23 | 2.4 × 10¹² | 1.6 × 10¹³ | 7.8 × 10¹⁴ | 43% | 0.5 |
| Example 24 | 24 | 1.7 × 10¹² | 1.1 × 10¹³ | 7.8 × 10¹⁴ | 50% | 0.5 |
| Example 25 | 25 | 1.3 × 10¹² | 8.3 × 10¹² | 7.8 × 10¹⁴ | 60% | 0.5 |
| Example 26 | 26 | 1.1 × 10¹² | 6.9 × 10¹² | 7.8 × 10¹⁴ | 65% | 0.5 |
| Example 27 | 27 | 9.0 × 10¹¹ | 5.7 × 10¹² | 7.8 × 10¹⁴ | 75% | 0.5 |
| Example 28 | 28 | 3.4 × 10¹² | 2.5 × 10¹³ | 7.8 × 10¹⁴ | 30% | 0.5 |
| Example 29 | 29 | 1.7 × 10¹² | 1.2 × 10¹³ | 7.8 × 10¹⁴ | 43% | 0.5 |
| Example 30 | 30 | 1.0 × 10¹² | 6.9 × 10¹² | 7.8 × 10¹⁴ | 50% | 0.5 |
| Example 31 | 31 | 7.1 × 10¹¹ | 4.7 × 10¹² | 7.8 × 10¹⁴ | 60% | 0.5 |
| Example 32 | 32 | 5.8 × 10¹¹ | 3.8 × 10¹² | 7.8 × 10¹⁴ | 75% | 0.5 |
| Example 33 | 33 | 5.5 × 10¹² | 4.0 × 10¹³ | 7.8 × 10¹⁴ | 30% | 0.5 |
| Example 34 | 34 | 3.0 × 10¹² | 2.0 × 10¹³ | 7.8 × 10¹⁴ | 43% | 0.5 |
| Example 35 | 35 | 2.0 × 10¹² | 1.3 × 10¹³ | 7.8 × 10¹⁴ | 50% | 0.5 |
| Example 36 | 36 | 1.6 × 10¹² | 1.0 × 10¹³ | 7.8 × 10¹⁴ | 60% | 0.5 |
| Example 37 | 37 | 9.9 × 10¹¹ | 6.1 × 10¹² | 7.8 × 10¹⁴ | 75% | 0.5 |
| Example 38 | 38 | 4.0 × 10¹² | 2.9 × 10¹³ | 7.8 × 10¹⁴ | 40% | 0.5 |
| Example 39 | 39 | 2.1 × 10¹² | 1.4 × 10¹³ | 7.8 × 10¹⁴ | 43% | 0.5 |
| Example 40 | 40 | 1.4 × 10¹² | 9.3 × 10¹² | 7.8 × 10¹⁴ | 50% | 0.5 |
| Example 41 | 41 | 9.4 × 10¹¹ | 6.2 × 10¹² | 7.8 × 10¹⁴ | 60% | 0.5 |
| Example 42 | 42 | 8.1 × 10¹¹ | 5.3 × 10¹² | 7.8 × 10¹⁴ | 63% | 0.5 |

| | | Ratio of Nb/Ti | | | | | |
|---|---|---|---|---|---|---|---|
| | | atomic number | | | | | |
| | | ratio at inside | | | | | |
| | | portion at 5% of | | | | | |
| | | primary particle | | | | | |
| | | diameter from | | | | | |
| | | surface of | | | | | |
| | Primary | particle with | | Evaluation | | | |
| | particle | respect to Nb/Ti | Nb content | | | Image | |
| | diameter | atomic number | with respect | Injection | | fineness | |
| | of metal | ratio at central | to Ti of | index | | [highlight | |
| Example | oxide | portion of | metal oxide | [injection | | image | |
| No. | (nm) | particle | particles/wt % | chargeability] | | smearing] | |
| Example 1 | 40 | 7.8 | 1.1% | A | 52.0% | A | 10.7 |
| Example 2 | 40 | 7.8 | 1.1% | C | 35.0% | A | 11.0 |
| Example 3 | 40 | 7.8 | 1.1% | B | 47.0% | A | 11.0 |
| Example 4 | 40 | 7.8 | 1.1% | A | 53.0% | A | 10.4 |
| Example 5 | 40 | 7.8 | 1.1% | A | 53.0% | B | 9.4 |
| Example 6 | 40 | 7.8 | 1.1% | A | 53.0% | C | 8.0 |
| Example 7 | 40 | 7.8 | 1.1% | B | 42.0% | A | 10.8 |
| Example 8 | 40 | 7.8 | 1.1% | A | 50.0% | A | 10.7 |
| Example 9 | 40 | 7.8 | 1.1% | A | 54.0% | A | 10.3 |
| Example 10 | 40 | 7.8 | 1.1% | A | 55.0% | B | 9.3 |
| Example 11 | 68 | 8.1 | 1.1% | B | 44.0% | B | 9.5 |
| Example 12 | 68 | 8.1 | 1.1% | A | 52.0% | B | 9.4 |
| Example 13 | 68 | 8.1 | 1.1% | A | 54.0% | B | 9.3 |
| Example 14 | 68 | 8.1 | 1.1% | A | 56.0% | B | 9.2 |
| Example 15 | 68 | 8.1 | 1.1% | A | 56.0% | B | 9.0 |
| Example 16 | 21 | 7.7 | 1.1% | C | 37.0% | A | 10.0 |
| Example 17 | 21 | 7.7 | 1.1% | B | 40.0% | B | 9.9 |
| Example 18 | 21 | 7.7 | 1.1% | B | 41.0% | B | 9.8 |
| Example 19 | 21 | 7.7 | 1.1% | B | 42.0% | B | 9.7 |
| Example 20 | 21 | 7.7 | 1.1% | B | 43.0% | B | 9.5 |
| Example 21 | 40 | 7.8 | 1.1% | B | 40.0% | A | 11.0 |
| Example 22 | 40 | 7.8 | 1.1% | B | 43.0% | A | 11.0 |
| Example 23 | 40 | 7.8 | 1.1% | B | 47.0% | A | 11.0 |
| Example 24 | 40 | 7.8 | 1.1% | A | 49.0% | A | 10.8 |
| Example 25 | 40 | 7.8 | 1.1% | A | 50.0% | A | 10.6 |
| Example 26 | 40 | 7.8 | 1.1% | A | 50.0% | A | 10.2 |
| Example 27 | 40 | 7.8 | 1.1% | A | 50.0% | B | 9.7 |
| Example 28 | 68 | 8.1 | 1.1% | B | 41.0% | B | 9.8 |
| Example 29 | 68 | 8.1 | 1.1% | B | 49.0% | B | 9.7 |
| Example 30 | 68 | 8.1 | 1.1% | A | 50.0% | B | 9.6 |
| Example 31 | 68 | 8.1 | 1.1% | A | 51.0% | B | 9.5 |
| Example 32 | 68 | 8.1 | 1.1% | A | 52.0% | B | 9.2 |
| Example 33 | 21 | 7.7 | 1.1% | C | 32.0% | A | 10.4 |
| Example 34 | 21 | 7.7 | 1.1% | C | 37.0% | A | 10.4 |
| Example 35 | 21 | 7.7 | 1.1% | C | 37.0% | A | 10.2 |
| Example 36 | 21 | 7.7 | 1.1% | C | 38.0% | A | 10.0 |
| Example 37 | 21 | 7.7 | 1.1% | C | 39.0% | B | 9.9 |
| Example 38 | 60 | 8.0 | 1.1% | B | 45.0% | A | 10.8 |
| Example 39 | 60 | 8.0 | 1.1% | B | 48.0% | A | 10.7 |
| Example 40 | 60 | 8.0 | 1.1% | A | 50.0% | A | 10.7 |
| Example 41 | 60 | 8.0 | 1.1% | A | 51.0% | A | 10.5 |
| Example 42 | 60 | 8.0 | 1.1% | A | 51.0% | A | 10.1 |

TABLE 7

| | | | | | Content ratio | |
|---|---|---|---|---|---|---|
| | | Resistance of | Resistance of | | of metal | |
| | | protection | protection | Resistance | oxide in | Thickness of |
| | Electrophotographic | layer | layer | of resin | protection | protection |
| Example | photosensitive | under HH | under NN | under HH | layer | layer |
| No. | member No. | environment | environment | environment | (vol %) | (μm) |
| Example 43 | 43 | 5.1 × 10¹² | 3.6 × 10¹³ | 7.8 × 10¹⁴ | 40% | 0.5 |
| Example 44 | 44 | 2.6 × 10¹² | 1.7 × 10¹³ | 7.8 × 10¹⁴ | 43% | 0.5 |
| Example 45 | 45 | 1.8 × 10¹² | 1.2 × 10¹³ | 7.8 × 10¹⁴ | 50% | 0.5 |
| Example 46 | 46 | 1.4 × 10¹² | 8.8 × 10¹² | 7.8 × 10¹⁴ | 60% | 0.5 |
| Example 47 | 47 | 9.5 × 10¹¹ | 6.0 × 10¹² | 7.8 × 10¹⁴ | 63% | 0.5 |
| Example 48 | 48 | 2.8 × 10¹² | 1.9 × 10¹³ | 7.8 × 10¹⁴ | 43% | 0.5 |
| Example 49 | 49 | 1.5 × 10¹² | 9.4 × 10¹² | 7.8 × 10¹⁴ | 60% | 0.5 |
| Example 50 | 50 | 1.9 × 10¹² | 1.3 × 10¹³ | 7.8 × 10¹⁴ | 43% | 0.5 |
| Example 51 | 51 | 8.3 × 10¹¹ | 5.4 × 10¹² | 7.8 × 10¹⁴ | 60% | 0.5 |
| Example 52 | 52 | 3.1 × 10¹² | 1.9 × 10¹³ | 7.8 × 10¹⁴ | 50% | 0.5 |
| Example 53 | 53 | 3.9 × 10¹² | 2.1 × 10¹³ | 7.8 × 10¹⁴ | 50% | 0.5 |
| Example 54 | 54 | 4.4 × 10¹² | 2.6 × 10¹³ | 7.8 × 10¹⁴ | 50% | 0.5 |
| Example 55 | 55 | 2.1 × 10¹² | 1.3 × 10¹³ | 7.8 × 10¹⁴ | 50% | 0.5 |
| Example 56 | 56 | 8.8 × 10¹¹ | 6.5 × 10¹² | 7.8 × 10¹⁴ | 50% | 0.5 |
| Example 57 | 57 | 2.5 × 10¹² | 1.5 × 10¹³ | 7.8 × 10¹⁴ | 50% | 0.5 |
| Example 58 | 58 | 1.0 × 10¹² | 1.1 × 10¹³ | 7.8 × 10¹⁴ | 50% | 0.5 |
| Example 59 | 59 | 3.3 × 10¹³ | 9.0 × 10¹³ | 7.8 × 10¹⁴ | 30% | 0.5 |
| Example 60 | 61 | 1.1 × 10¹² | 7.1 × 10¹² | 7.8 × 10¹⁴ | 30% | 0.5 |
| Example 61 | 62 | 8.8 × 10¹¹ | 6.1 × 10¹² | 7.8 × 10¹⁴ | 50% | 0.5 |
| Example 63 | 63 | 3.1 × 10¹² | 1.3 × 10¹³ | 7.8 × 10¹⁴ | 50% | 0.5 |
| Example 64 | 68 | 1.6 × 10¹² | 9.9 × 10¹² | 7.8 × 10¹⁴ | 50% | 0.5 |
| Example 65 | 69 | 1.1 × 10⁸ | 3.1 × 10⁹ | 7.8 × 10¹⁴ | 30% | 0.5 |
| Example 66 | 70 | 1.1 × 10⁹ | 2.5 × 10¹⁰ | 7.8 × 10¹⁴ | 30% | 0.5 |
| Example 67 | 71 | 1.2 × 10¹² | 7.9 × 10¹² | 2.5 × 10¹³ | 43% | 0.5 |
| Example 68 | 72 | 7.8 × 10¹¹ | 4.9 × 10¹² | 2.5 × 10¹³ | 50% | 0.5 |
| Example 69 | 73 | 6.1 × 10¹¹ | 3.8 × 10¹² | 2.5 × 10¹³ | 60% | 0.5 |
| Example 70 | 74 | 1.6 × 10¹⁰ | 2.2 × 10¹¹ | 6.1 × 10¹¹ | 50% | 0.5 |
| Example 71 | 78 | 8.8 × 10⁷ | 9.9 × 10⁸ | 2.2 × 10¹⁴ | 30% | 0.5 |
| Example 72 | 79 | 8.8 × 10¹¹ | 4.6 × 10¹² | 3.6 × 10¹² | 36% | 3.0 |
| Example 73 | 80 | 5.0 × 10¹¹ | 2.2 × 10¹² | 3.6 × 10¹² | 36% | 3.0 |
| Comparative | 60 | 4.4 × 10¹² | 2.9 × 10¹³ | 7.8 × 10¹⁴ | 50% | 0.5 |
| Example 1 | | | | | | |
| Comparative | 64 | 3.1 × 10¹¹ | 3.3 × 10¹² | 7.8 × 10¹⁴ | 50% | 0.5 |
| Example 2 | | | | | | |
| Comparative | 65 | 6.5 × 10¹¹ | 6.6 × 10¹² | 7.8 × 10¹⁴ | 25% | 0.5 |
| Example 3 | | | | | | |
| Comparative | 66 | 4.8 × 10¹¹ | 4.6 × 10¹² | 7.8 × 10¹⁴ | 30% | 0.5 |
| Example 4 | | | | | | |
| Comparative | 67 | 9.0 × 10¹⁰ | 8.5 × 10¹¹ | 7.8 × 10¹⁴ | 75% | 0.5 |
| Example 5 | | | | | | |
| Comparative | 75 | 2.5 × 10¹⁰ | 5.2 × 10¹¹ | 2.2 × 10¹⁴ | 38% | 2.5 |
| Example 6 | | | | | | |
| Comparative | 76 | 3.1 × 10¹⁰ | 4.4 × 10¹¹ | 6.1 × 10¹¹ | 41% | 0.1 |
| Example 7 | | | | | | |
| Comparative | 77 | 1.2 × 10⁸ | 2.0 × 10⁹ | 2.2 × 10¹⁴ | 31% | 2.0 |
| Example 8 | | | | | | |

| | | Ratio of Nb/Ti | | | | | |
|---|---|---|---|---|---|---|---|
| | | atomic number | | | | | |
| | | ratio at inside | | | | | |
| | | portion at 5% of | | | | | |
| | | primary particle | | | | | |
| | | diameter from | | | | | |
| | | surface of | | | | | |
| | Primary | particle with | | Evaluation | | | |
| | particle | respect to Nb/Ti | Nb content | | | Image | |
| | diameter | atomic number | with respect | Injection | | fineness | |
| | of metal | ratio at central | to Ti of | index | | [highlight | |
| Example | oxide | portion of | metal oxide | [injection | | image | |
| No. | (nm) | particle | particles/wt % | chargeability] | | smearing] | |
| Example 43 | 30 | 7.7 | 1.1% | B | 42% | A | 11.0 |
| Example 44 | 30 | 7.7 | 1.1% | B | 46% | A | 11.0 |
| Example 45 | 30 | 7.7 | 1.1% | B | 47% | A | 10.9 |
| Example 46 | 30 | 7.7 | 1.1% | B | 49% | A | 10.8 |
| Example 47 | 30 | 7.7 | 1.1% | B | 49% | A | 10.5 |
| Example 48 | 25 | 7.7 | 1.1% | B | 40% | A | 10.5 |
| Example 49 | 25 | 7.7 | 1.1% | B | 41% | A | 10.8 |
| Example 50 | 65 | 7.9 | 1.1% | B | 48% | A | 10.5 |
| Example 51 | 65 | 7.9 | 1.1% | A | 51% | A | 10.7 |
| Example 52 | 40 | 7.9 | 0.2% | B | 46% | A | 10.7 |
| Example 53 | 36 | 4.2 | 0.1% | B | 45% | A | 10.7 |
| Example 54 | 34 | 2.0 | 0.1% | C | 35% | A | 10.8 |
| Example 55 | 40 | 7.8 | 0.4% | B | 48% | A | 10.7 |
| Example 56 | 40 | 7.9 | 2.2% | A | 53% | A | 10.7 |
| Example 57 | 40 | 7.8 | 1.1% | B | 40% | A | 10.7 |
| Example 58 | 40 | — | <0.1% | B | 38% | A | 10.0 |
| Example 59 | 40 | — | <0.1% | D | 20% | A | 10.0 |
| Example 60 | 20 | — | <0.1% | C | 32% | B | 9.5 |
| Example 61 | 20 | — | <0.1% | C | 32% | B | 9.2 |
| Example 63 | 70 | — | <0.1% | B | 43% | B | 9.5 |
| Example 64 | 40 | 7.7 | 1.1% | B | 44% | A | 10.1 |
| Example 65 | 20 | — | <0.1% | C | 37% | B | 9.1 |
| Example 66 | 20 | — | <0.1% | C | 35% | B | 9.5 |
| Example 67 | 40 | 7.8 | 1.1% | B | 45% | A | 10.7 |
| Example 68 | 40 | 7.8 | 1.1% | B | 49% | A | 10.6 |
| Example 69 | 40 | 7.8 | 1.1% | A | 51% | A | 10.3 |
| Example 70 | 40 | 7.8 | 1.1% | A | 51% | B | 9.9 |
| Example 71 | 20 | — | <0.1% | C | 38% | C | 8.5 |
| Example 72 | 30 | — | <0.1% | C | 30% | B | 9.0 |
| Example 73 | 50 | — | <0.1% | C | 32% | C | 8.8 |
| Comparative | 17 | — | <0.1% | D | 25% | D | 7.7 |
| Example 1 | | | | | | | |
| Comparative | 100 | — | <0.1% | C | 38% | E | 6.0 |
| Example 2 | | | | | | | |
| Comparative | 100 | — | <0.1% | C | 37% | E | 6.8 |
| Example 3 | | | | | | | |
| Comparative | 100 | — | <0.1% | B | 48% | E | 6.4 |
| Example 4 | | | | | | | |
| Comparative | 100 | — | <0.1% | A | 52% | F | 5.5 |
| Example 5 | | | | | | | |
| Comparative | 350 | — | <0.1% | C | 37% | F | 5.5 |
| Example 6 | | | | | | | |
| Comparative | 100 | — | <0.1% | C | 36% | D | 7.1 |
| Example 7 | | | | | | | |
| Comparative | 250 | — | <0.1% | D | 26% | F | 5.1 |
| Example 8 | | | | | | | |

According to the present disclosure, the electrophotographic photosensitive member capable of suppressing highlight image smearing even under a high-temperature and high-humidity environment while maintaining high injection chargeability can be provided.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-098930, filed Jun. 20, 2022 and Japanese Patent Application No. 2023-031096, filed Mar. 1, 2023, which are hereby incorporated by reference herein in their entirety.

What is claimed is:

1. An electrophotographic photosensitive member comprising:
a surface layer containing a binder resin and metal oxide particles,
wherein an average primary particle diameter of the metal oxide particles measured from a cross-section of the surface layer is 20 to 70 nm, and
wherein a content ratio of the metal oxide particles in the surface layer measured from the cross-section of the surface layer is 30 to 75 vol % with respect to a total volume of the surface layer.

2. The electrophotographic photosensitive member according to claim 1, wherein the surface layer has a thickness of 0.1 to 1.5 μm.

3. The electrophotographic photosensitive member according to claim 1, wherein the content ratio of the metal oxide particles in the surface layer is 42 to 65 vol % with respect to the total volume of the surface layer.

4. The electrophotographic photosensitive member according to claim 1, wherein a powder resistivity A (Ω·cm) of the metal oxide particles satisfies expression (1):
1.0×10³≤A≤1.0×10¹⁰ (1).

5. The electrophotographic photosensitive member according to claim 1, wherein a volume resistivity C (Ω·cm) of the surface layer at a temperature of 32.5° C. and a humidity of 80% RH satisfies expression (2):
1.0×10¹¹≤C≤1.0×10¹³ (2).

6. The electrophotographic photosensitive member according to claim 1, wherein a volume resistivity D (Ω·cm) of the surface layer at a temperature of 23.0° C. and a humidity of 55% RH satisfies expression (3):
1.0×10¹²≤D≤1.0×10¹⁴ (3).

7. The electrophotographic photosensitive member according to claim 1, wherein a volume resistivity B (Ω·cm) of the binder resin at a temperature of 32.5° C. and a humidity of 80% RH satisfies expression (4):
1.0×10¹²≤B≤1.0×10¹⁵ (4).

8. The electrophotographic photosensitive member according to claim 1, wherein the metal oxide particles are niobium-containing titanium oxide particles.

9. The electrophotographic photosensitive member according to claim 8, wherein, in energy-dispersive X-ray spectroscopy (EDS) analysis of each of the metal oxide particles with a scanning transmission electron microscope (STEM), a niobium/titanium atomic number ratio at an inside portion at 5% of a primary particle diameter from a surface of the metal oxide particle is 2.0 or more times as high as a niobium/titanium atomic number ratio at a center of the metal oxide particle.

10. The electrophotographic photosensitive member according to claim 1, wherein a volume resistivity C (Ω·cm) of the surface layer at a temperature of 32.5° C. and a humidity of 80% RH and a volume resistivity D (Ω·cm) of the surface layer at a temperature of 23.0° C. and a humidity of 55% RH satisfy expression (5):
0.05≤D/C≤1.0 (5).

11. The electrophotographic photosensitive member according to claim 1, wherein the metal oxide particles are each surface-treated with a compound having a silicon atom.

12. The electrophotographic photosensitive member according to claim 1, wherein the surface layer contains, as the binder resin, at least one resin selected from the group consisting of: a polyarylate resin; a polycarbonate resin; and an acrylic resin.

13. A process cartridge comprising:
an electrophotographic photosensitive member including a surface layer containing a binder resin and metal oxide particles; and
at least one unit selected from the group consisting of a charging unit, a developing unit, a transfer unit, and a cleaning unit,
the process cartridge integrally supporting the electrophotographic photosensitive member and the at least one unit, and being detachably attachable onto a main body of an electrophotographic apparatus,
wherein an average primary particle diameter of the metal oxide particles measured from a cross-section of the surface layer is 20 to 70 nm, and
wherein a content ratio of the metal oxide particles in the surface layer measured from the cross-section of the surface layer is 30 to 75 vol % with respect to a total volume of the surface layer.

14. An electrophotographic apparatus comprising:
an electrophotographic photosensitive member including a surface layer containing a binder resin and metal oxide particles; and
a charging unit, an exposing unit, a developing unit, and a transfer unit,
wherein an average primary particle diameter of the metal oxide particles measured from a cross-section of the surface layer is 20 to 70 nm, and
wherein a content ratio of the metal oxide particles in the surface layer measured from the cross-section of the surface layer is 30 to 75 vol % with respect to a total volume of the surface layer.
